(19) United States
(12) Patent Application Publication
(10) Pub. No.: US 2013/0149012 A1
(43) Pub. Date: Jun. 13, 2013

(54) MAGNET ROLL

(71) Applicant: PANASONIC CORPORATION, Osaka (JP)

(72) Inventors: Keiichi Nakao, Osaka (JP); Yukihiro Shimasaki, Hyogo (JP); Atsushi Iwase, Mie (JP); Koji Shimoyama, Mie (JP)

(73) Assignee: PANASONIC CORPORATION, Osaka (JP)

(21) Appl. No.: 13/674,763

(22) Filed: Nov. 12, 2012

Related U.S. Application Data
(63) Continuation-in-part of application No. 13/098,895, filed on May 2, 2011.
Application No. 13/098,895 is a division of application No. 12/339,826, filed on Dec. 19, 2008, now Pat. No. 8,178,188.
Application No. 12/339,826 is a continuation-in-part of application No. 11/048,737, filed on Feb. 3, 2005, now abandoned.
Application No. 11/048,737 is a division of application No. 10/311,222, filed on Mar. 21, 2003, now Pat. No. 6,855,367.

(30) Foreign Application Priority Data
Apr. 20, 2001 (JP) 2001-122442
Nov. 28, 2008 (JP) 2008-303972

(51) Int. Cl. G03G 15/09

(52) U.S. Cl. CPC G03G 15/0921
USPC 399/277

(57) ABSTRACT

A magnet roll for development for a printer, a copying machine, or the like. The magnet roll comprises a metal pipe provided with recesses formed on a surface thereof and portion maintaining an original metal surface, and a magnet inserted into the metal pipe. Recesses on the surface of the metal pipe are formed by etching using a resist formed by an inkjet process, and irregularities based on crystal grains of metal are formed on an inner surface of each of the recesses and can effectively carry toner that is carried by carrier to a portion of latent images.

### BACKGROUND

1. Technical Field

The present technical field relates to a method of manufacturing ceramic electronic components such as ceramic parts, laminated ceramic capacitors, LC filters, and composite high-frequency electronic components. The method uses a computer-controlled ink-jet apparatus, which jets ink to form the foregoing various electronic components on non-contact basis.

Further, the exemplary embodiment enables a computer-controlled inkjet apparatus to form a high-precision pattern with least oozing and dropping of ink on the surface of low ink acceptability, such as a metal surface. Also on the surface of a three-dimensional member, a high-precision pattern can be formed with least oozing and dropping of ink. Furthermore, on the surface of a member, for example, a three-dimensional metal pipe which exhibits low ink acceptability, a high-precision pattern can be formed with least oozing and dripping of ink. An ink pattern provided in accordance with the exemplary embodiment can also be used as an etching resist. Therefore, it can be used for manufacturing various types of electronic components such as magnet rolls for printers and the like.

Further, using a magnet roll according to the exemplary embodiment makes it possible to provide a high-quality image even when a printer or a copying machine is used for a long time or in high-speed printing.

2. Background Art

A conventional method of manufacturing various ceramic electronic components, first of all, prints a predetermined electrode pattern on an unbaked ceramic member such as a green sheet of ceramic by, e.g., screen printing. Next, laminate the ceramic green sheets on which the electrode patterns are printed, then cut the laminated sheet in a given shape, and bake them. Finally form external electrodes. Another method forms conductive or insulating patterns on an unbaked ceramic member, then bake the member.

A conventional printing method such as a screen printing can form electrodes in an identical shape; however, it is not good at forming electrodes of different patterns, i.e., small batches of a variety of products, or forming electrodes on non-contact basis, or forming electrodes at a high speed. Japanese Patent Application Non-examined Publication No. 2000-327964 and No. 2000-182889 disclose methods of manufacturing electronic components using inkjet for overcoming the foregoing problems. However, forming an electrode pattern using inkjet depends on surface condition of a substrate on which the pattern is to be printed. Thus some ceramic green sheet repels water or oil of ink, which produces non-uniform thickness of the printed pattern. As a result, a desirable electrode pattern cannot be formed.

Problems of ink acceptability of those substrates to be printed are described with reference to FIG. 11. FIG. 11A and FIG. 11B show an electrode-shape required as a ceramic electronic component. Electrode pattern 1 shown in FIG. 11A has no pin-hole therein, and is required to have a uniform thickness and to be a highly accurate fine pattern. Therefore, in FIG. 11B, electrode pattern 1 is formed on a ceramic green sheet on base film 2 in a uniform thickness.

FIG. 11C illustrates an electrode pattern formed with conventional inkjet. As shown in FIG. 11C, the electrode patterns formed with inkjet on the ceramic green sheet are deformed due to repelling the jetted ink on the surface because the ceramic green sheet does not have ink acceptability. FIG. 11D is a sectional view of FIG. 11C and shows a cross section of the electrode patterns formed with the conventional inkjet. As shown in FIG. 11C and FIG. 11D, electrode patterns 4 are repelled and deformed, which is caused by poor wetness, namely, low ink-acceptability of the ceramic green sheet on which patterns are to be printed. This is a similar phenomenon as a water drop is repelled on a base substrate which has been processed to repel water and oil. If such an ink- repellant phenomenon occurs in an electrode pattern, pinhole 5 tends to be formed inside electrode pattern 4. As a result, repelled electrode pattern 4 ends up having non-uniform thickness.

As such, jetted ink landed on the surface of the substrate is deformed as shown in FIG. 11C and FIG. 11D because the viscosity of the ink is as low as 0.01-0.1 poise and extremely subjected to surface tension of the substrate on which patterns are to be printed. Thus the landed ink is deformed before the ink is dried or cured. In the case of screen printing, on the other hand, the viscosity of ink is as high as several hundreds poise, and the ink is hardly deformed. In a case of an inkjet printer using papers available in the consumer market, since landed ink soaks into the paper, such uneven printing does not occur. However, in the case of ceramic electronic component posed in the exemplary embodiment, if jetted ink soaks into a ceramic green sheet, electrical insulation or reliability of a finished component is sometimes substantially degraded. Quick-drying of landed ink is one of measures against such a problem. However, quick-drying ink tends to dry and harden at a tip of a printer head of an inkjet apparatus, and eventually clogs the printer head. Therefore, it is not good at producing stable print for long hours.

As discussed above, efforts have been made for printing given electrode-patterns accurately using inkjet; however, as shown in FIG. 11C and FIG. 11D, irregular bumps and dips are formed in a sectional view of electrode patterns, thus a required electronic component cannot be produced.

An apparatus that forms a given three-dimensional structure using laser beam is recently commercialized. This apparatus exposes photo-sensitive resin to laser beam and cures the resin, and repeats this operation plural times before forming the given three-dimensional structure. The finished three-dimensional structure is formed of resin, therefore if it is sintered, an electronic component cannot be produced. If an electrode or a member for forming an electronic component such as ceramic is added to this kind of photo-sensitive resin, it becomes difficult to cure this subject with light.

Japanese Patent Application Non-examined Publication No. H02-415702 discloses a method of forming a three-dimensional structure using inkjet. This method deposits a first layer of powder material at a limited area, then deposits binder at a selected area of the powder material layer, so that the bound powder material is formed at the selected area before a component is produced. This method repeats the foregoing operation selected number of times for producing a given plastic component. Thus a successive layer is formed at the selected area of the bound powder material. Then un-bound powder material is removed, whereby a three-dimensional structure is formed. However, in the case of the disclosure discussed above, the inkjet apparatus jets binder for powder, and the binder does not include the powder. When the three-dimensional structure is taken out, surplus powder should be brushed off. Further, this disclosure has difficulty for forming a three-dimensional structure including plural members such as ceramic, electrodes and so on, which are necessary for an electronic component.

In addition, a further higher speed or a higher printing quality is demanded for a printing apparatus using toner, such as a laser printer or a copying machine. An increase in an amount of toner transfer per unit time, uniformity in supplying toner, stability over a long period, or the like is demanded, in addition to miniaturization of a magnet roll along with miniaturization of the printer, for the magnet roll for supplying toner of each color to a photosensitive drum that constitutes the laser printer.

### SUMMARY

A magnet roll according to various embodiments carries toner for development together with carrier to a portion of a latent image. The magnet roll includes a roll made of metal including recesses provided in a pattern on a surface of the roll and a magnet provided inside the roll. The recesses are produced by the steps of providing a base layer on the surface of the roll to make the surface of the roll made of metal as a surface of accepting ink for inkjet; spraying the ink onto a surface of the base layer by means of an inkjet method to forma pattern that is insoluble by an etching solution for etching the metal by a gelling reaction or interaction between the base layer and the ink;

etching the surface of the roll made of metal on which the pattern that is insoluble pattern is formed to form recesses on the surface of the roll; and removing the insoluble pattern. A surface of an inner wall of each of the recesses includes irregularities that are generated by grain boundaries resulted from etching of grains constituting the metal, a size of the irregularities corresponds to a grain diameter of the toner, the irregularities are formed on an entire surface of the inner wall of each of the recesses, and the surface of the roll excluding the recesses maintains an original metal surface.

### BRIEF DESCRIPTION OF THE DRAWINGS

FIG. 1A shows a sectional view of formation of an electrode pattern on a base layer in accordance with a first exemplary embodiment.

FIG. 1B shows a sectional view of the formation of the electrode pattern on the base layer in accordance with the first exemplary embodiment.

FIG. 1C shows a sectional view of the formation of the electrode pattern on the base layer in accordance with the first exemplary embodiment.

FIG. 2A shows a perspective view of an electrode pattern with a base layer and that without a base layer.

FIG. 2B shows characteristics of the electrode pattern with the base layer and that without the base layer.

FIG. 3A shows a sectional view illustrating an electrode pattern with a base layer and that without a base layer due to drying.

FIG. 3B shows a sectional view illustrating an electrode pattern with a base layer and that without a base layer due to drying.

FIG. 3C shows a sectional view illustrating an electrode pattern with a base layer and that without a base layer due to drying.

FIG. 4A illustrates a status when a printer discharges a sheet.

FIG. 4B illustrates a status when a printer discharges a sheet.

FIG. 4C illustrates a status when a printer discharges a sheet.

FIG. 5 illustrates that solvent contained in ink soaks into a base layer, whereby the ink is set.

FIGS. 6A and 6B illustrate that solvent contained in ink soaks into a base layer, whereby the ink is set.

FIG. 7 illustrates a case where gelling reaction is used.

FIG. 8 illustrates a case where reaction between organic components.

FIG. 9 illustrates a case where reaction between inks thereby forming a three dimensional structure.

FIG. 10 illustrates a sectional view of a three dimensional structure formed in an exemplary embodiment.

FIG. 11A shows a plan view of a required electrode pattern.

FIG. 11B shows a sectional view of the required electrode pattern.

FIG. 11C shows a plan view of an electrode pattern formed by a conventional method.

FIG. 11D shows a sectional view of the electrode pattern formed by a conventional method.

FIG. 12A shows a perspective view of a metal pipe which is a material of a magnet roll to be applied of the base layer according to an exemplary embodiment.

FIG. 12B is a perspective view showing the metal pipe shown in FIG. 12A coated at the surface with the base layer.

FIG. 12C is a perspective view showing how a pattern is printed by droplets jetted from an inkjet apparatus.

FIG. 13A is a cross sectional view showing how the inkjet apparatus jets the droplets on the base layer for the printing of the pattern.

FIG. 13B is a cross sectional view showing that the droplet jetted from the inkjet apparatus lands on the base layer to form a resist pattern.

FIG. 13C is a cross sectional view showing the state after the base layer is removed.

FIG. 14A is a cross sectional view showing a state after the surface of the metal pipe is etched using the resist pattern as an etching resist according to an exemplary embodiment.

FIG. 14B is a cross sectional view showing how the resist pattern is removed.

FIG. 14C is a perspective view of the metal pipe provided at the surface with recesses having a predetermined specific pattern.

FIG. 15A is a cross sectional view showing how toner and a carrier slip on a smooth inner wall surface of a recess.

FIG. 15B is a cross sectional showing how toner and a carrier are held retained without slipping on a roughened inner wall surface of a recess according to an exemplary embodiment.

FIG. 16A is an electron micrograph showing an enlarged view of a part of a surface of a magnet roll according to an exemplary embodiment.

FIG. 16B is a schematic diagram used for explaining the electron micrograph of FIG. 16A.

FIG. 17A is an electron micrograph of a surface of an inner wall of a recess formed on the surface of the magnet roll according to the exemplary embodiment.

FIG. 17B is a schematic diagram used for explaining the electron micrograph of FIG. 17A.

FIG. 18A is a perspective view illustrating a state before machine processing marks are provided.

FIG. 18B is a perspective view illustrating a state provided with the processing marks.

FIG. 18C is a perspective view illustrating a state with the processing marks and recesses provided on the surface of the magnet roll according to the exemplary embodiment.

FIG. 19A is a cross sectional view of the magnet roll provided with the processing marks.

FIG. 19B is a cross sectional view illustrating a part of a magnet roll provided with a plurality of types of processing marks.

FIG. 20A is a cross sectional view illustrating an initial state of a magnet roll.

FIG. 20B is a cross sectional view of the magnet roll after a long period of use.

FIG. 20C is a graph showing how a height difference due to the processing marks on the surface of the magnet roll changes with a running time.

FIG. 21A is a cross sectional view illustrating an initial surface condition of a conventional magnet roll with conventional processing marks having no orientation.

FIG. 21B is a cross sectional view illustrating a surface condition of the conventional magnet roll with the conventional processing marks having no orientation after a long period of use.

FIG. 21C is a graph showing how a height difference due to the conventional processing marks on the surface of the conventional magnet roll changes with a running time.

FIG. 22A is an electron micrograph of a roll surface excluding the recesses of the magnet roll according to the exemplary embodiment.

FIG. 22B is a schematic diagram used for explaining FIG. 22A.

FIG. 23A is a photograph showing one example of a pattern of the recesses provided on the surface of the magnet roll according to the exemplary embodiment.

FIG. 23B is a schematic diagram used for explaining FIG. 23A.

### DETAILED DESCRIPTION OF THE EMBODIMENTS

### Exemplary Embodiment 1

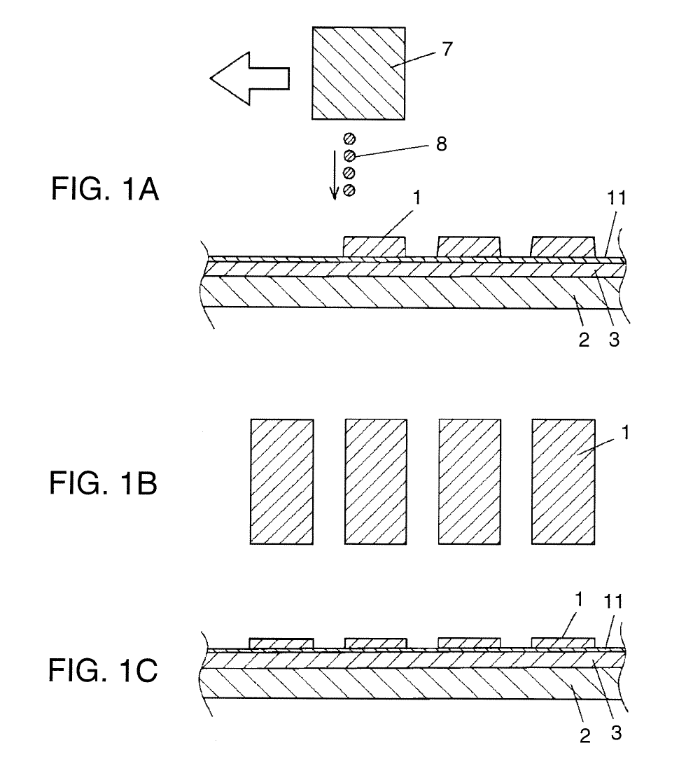

In this embodiment, formation of an electrode pattern onto a ceramic green sheet is demonstrated. FIG. 1A-FIG. 1C illustrate a method of forming an electrode pattern on the surface of a ceramic green sheet having a base layer. FIG. 1A shows a sectional view illustrating a method of forming a given electrode pattern by inkjet method on a ceramic green sheet having a base layer. FIG. 1B shows the given electrode pattern thus formed. In FIG. 1A inkjet apparatus 7 is loaded with predetermined ink, and jets droplet 8 responsive to an external signal. The external signal can adjust not only jetting of droplet 8 but also a size (volume, quantity and diameter) of droplet 8. On base film 2, ceramic green sheet 3 is formed, and on top the surface of sheet 3, burn-off base layer 11 that is a feature is formed. According to the exemplary embodiment, plural droplets 8 jetted from inkjet apparatus 7 land on burn-off base layer 11 and form a given electrode-ink-pattern 1.

An example of the electrode pattern thus formed on the ceramic green sheet is shown in FIG. 1B, in which electrode pattern 1 free from oozing is accurately formed as the design requests. FIG. 1C is a sectional view cut along a line at anyplace in FIG. 1B. As shown in FIG. 1C, electrode pattern 1 according to the exemplary embodiment is formed in an uniform thickness on burn-off base layer 11.

Burn-off base layer 11 of the exemplary embodiment is formed on the surface of ceramic green sheet 3, whereby droplet 8 after it landed on green sheet 3 is not flowed or repelled due to the gravity or the surface tension (the surface tension of the surface of ink, the surface tension of the base layer.) Burn-off base layer 11 of the exemplary embodiment is burnt off in a baking step prepared later and disappears, so that it does not adversely affect the reliability of the finished electronic component.

To be more specific about the foregoing method, ceramic green sheet 3 used in the first embodiment is formed by applying ceramic slurry onto resin film such that the solid content of the slurry becomes a thickness of several microns. The ceramic slurry is produced by mixing and dispersing ceramic powder, of which temperature characteristic shows B of EIAJ standard, and made of mainly barium titanate into mixed solution including butyl acetate, phthalate plasticizer, and butyral resin.

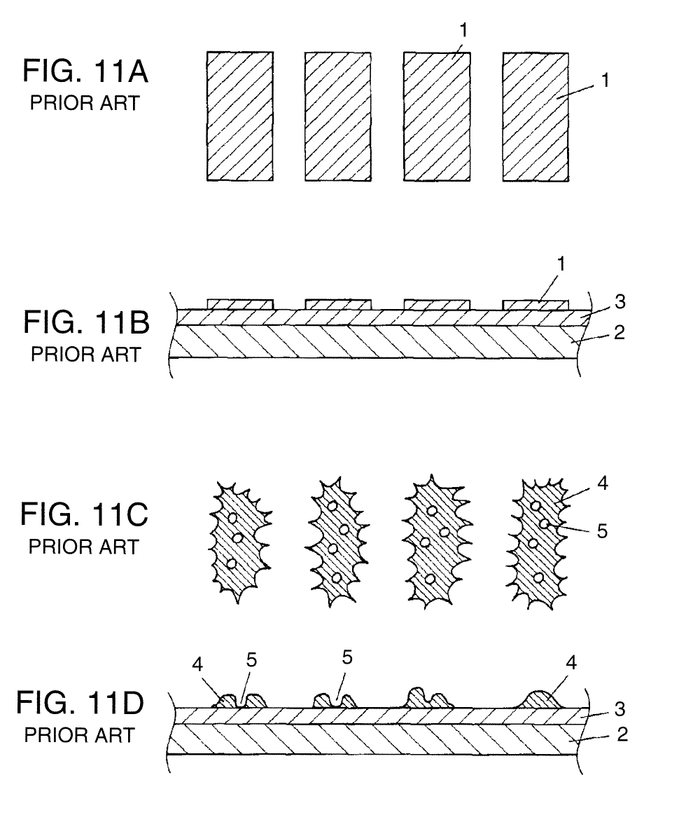

Next, an inkjet apparatus available in the consumer market prints the given electrode pattern 1 with commercial water soluble black ink on the ceramic green sheet 3. The result is shown in FIG. 11C. The ink lands on the ceramic green sheet and is repelled immediately like beads of water. As a result, target electrode pattern 1 cannot be formed. This is because the ceramic green sheet is not hydrophilic, and the water soluble ink landed does not soak into the surface of the sheet, but the ink is repelled by the surface tension of the base layer.

Thus water soluble resin is used as burn-off base layer 11, and the resin is dissolved in water and applied to the ceramic green sheet such that a dried thickness becomes 0.5 micron. In this embodiment, commercially available polyvinyl acetal (e.g., KW1 or KW3 manufactured by Sekisui Chemical Co. Ltd.) is used as water soluble resin. A commercially available inkjet apparatus jets the commercially available water-soluble black ink onto ceramic green sheet 3 on which burn-off base layer 11 is formed. The result is shown in FIG. 1B, i.e., accurate electrode pattern 1 free from deformation is obtained. Thus hydrophilic burn-off base layer 11 prepared on the poorly hydrophilic (highly water repellent) ceramic green sheet can prevent electrode pattern 1 from being deformed using water-soluble ink.

For the comparison purpose, the same test is done using a ceramic green sheet formed of water-soluble resin. Water-soluble polyvinyl acetal resin is dissolved in water, glycol (plasticizer), and alcohol (for adjusting a drying speed) to produce solution of water-soluble resin. The foregoing ceramic powder is mixed and dispersed into this solution to produce ceramic slurry. An applicator applies the slurry onto resin film such that a thickness of the slurry becomes several microns. The given electrode pattern 1 is printed on the surface of the slurry with the water-soluble black ink available in the market, then the water-soluble ink not only dissolves the water-soluble ceramic green sheet, but also deforms the electrode pattern, an eventually makes holes on the ceramic green sheet.

In other words, water-soluble jetted ink is repelled on the ceramic green sheet of non water-soluble, and water-soluble jetted ink on the water-soluble ceramic green sheet dissolves the sheet.

On the other hand, when non water-soluble (i.e., poorly ink acceptable) ceramic green sheet demonstrated in this embodiment is equipped with a thin hydrophilic burn-off base layer 11 on its surface, the green sheet obtains ink acceptability for water-soluble jetted ink and prevents the jetted ink from soaking into the sheet.

Next, a trial product of ink supposed to be used in an inkjet apparatus is employed in a similar experiment. The ink is made of nickel particles, which is turned into jet-ink using a method of manufacturing water-soluble ink, the method is disclosed in Japanese Patent Application Non-examined Publication No. H11-102615. The ink thus manufactured is used for printing on both surfaces of ceramic green sheet 3 and burn-off base layer 11 provided on top of sheet 3 using inkjet apparatus 7. On the sheet 3 of non water-soluble, the ink is greatly repelled and deformed due to water repellency of the surface. If water-soluble ceramic green sheet is used, the ink dissolves the sheet. On the other hand, on the surface of the burn-off base layer, the ink is not repelled but formed into a uniform thickness accurately. Being left for long hours, the ink keeps its pattern free from deformation.

Prepare several hundreds of ceramic sheets, each having burn-off base layer on which electrode pattern 1 is formed, then laminate 300 sheets such that electrode pattern 1 shifts by a given distance. Cut the 300 sheets into squares of 2.5 mm×1.6 mm size, then bake the cut pieces, and finally form electrodes to complete laminated ceramic capacitors. The laminated ceramic capacitor thus manufactured is excellent in both initial properties and reliability. A scanning electron microscope cannot observe burn-off base layer 11 on a cross section of this capacitor, because the base layer of the exemplary embodiment is burn off . The burn-off base layer made of mainly burn-off material such as resin is burn off and volatilized during the baking, and does not remain in the finished electronic component, thus the base layer does not adversely affect the finished product.

In a case of forming burn-off base layer 11 of only resin, the thickness of the base layer is preferably not more than 20 microns, and more preferably it is not more than 5 microns. If the thickness of burn-off base layer 11 made of mainly resin is not less than 20 microns, defectives such as inter layer peeling occur in some products. Adding a ceramic member inside burn-off base layer 11 is effective to prevent the inter layer peeling.

### Exemplary Embodiment 2

### Advantage of Reducing Unevenness

In the foregoing first embodiment, it is demonstrated that electrode pattern 1 is formed on the ceramic green sheet on which burn-off base layer 11 is prepared. In this second embodiment, it is demonstrated that uneven thickness of electrode film applied depends on the presence of burn-off base layer 11.

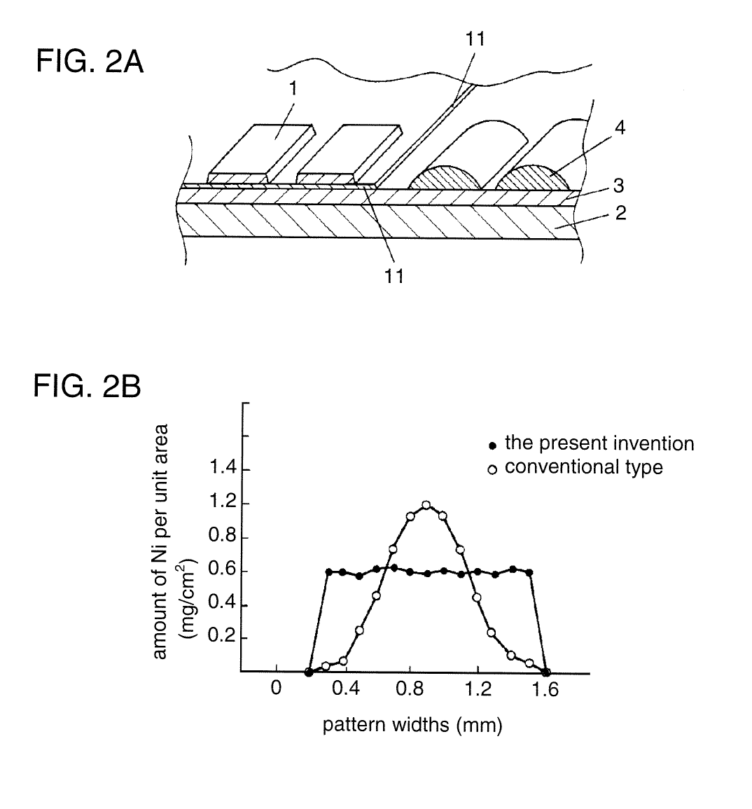

FIG. 2A illustrates a case where burn-off base layer 11 is formed on only parts of the surface of ceramic green sheet 3. The advantage of burn-off base layer 11 is described using FIG. 2A, which shows a uniform thickness at an area where burn-off base layer 11 is formed and greatly uneven thickness at electrode patterns 4 formed directly on the ceramic green sheet without base layer 11. FIG. 2B shows the thicknesses of electrode patterns 1 and 4 shown in FIG. 2A measured with fluorescent X-ray. In FIG. 2B, the X-axis represents pattern widths (mm) and the Y-axis represents applied amount of Ni per unit area (mg/mm²). The spot diameter of the fluorescent X-ray is 0.1 mm which increases resolution in measuring. In FIG. 2B, black circle indicates the electrode pattern with the burn-off base layer proposed by the exemplary embodiment and corresponds to electrode pattern 1 shown in FIG. 2A. In FIG. 2B, white circle ◯ indicates the electrode pattern without burn-off base layer 11 and corresponds to electrode pattern 4 with uneven thickness shown in FIG. 2A.

As shown in FIG. 2B, in the case of burn-off base layer 11 of the exemplary embodiment being available, an uniform thickness is obtained overall the pattern. On the other hand, in the case of burn-off base layer 11 being not available, a little amount of Ni is applied around electrode pattern 4 but a greater amount of Ni is applied at the center of electrode pattern 4. Thus substantially uneven application is observed in the axial direction.

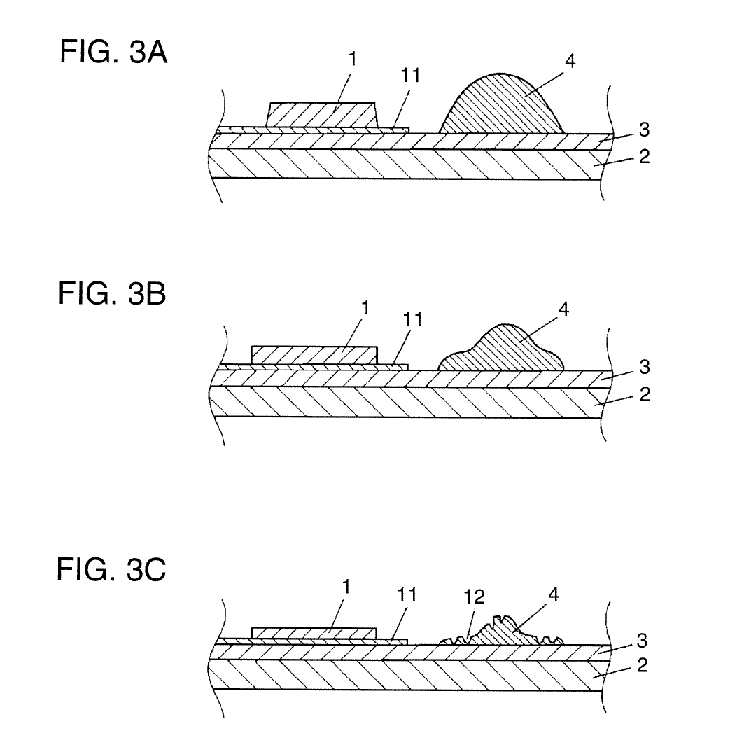

Next, the uneven application discussed above is detailed using FIG. 3, which monitors drying procedure of electrode patterns 1 and 4 shown in FIG. 2A with sectional views. On the left sides (burn-off base layer 11 is available) of FIG. 3A-FIG. 3C, a droplet (not shown) jetted from an inkjet apparatus (not shown) lands on burn-off base layer 11 and forms pattern 1 as shown in FIG. 3A, and solvent component in the ink is volatilized with a lapse of time. Then the ink is gradually dried and thinned keeping the uniform thickness and the shape shown in the sectional view as shown in FIG. 3B and FIG. 3C.

On the other hand, in the right area where burn-off base layer 11 is not formed, a droplet (not shown) landed on the ceramic green sheet of water repellency is repelled as if a bead of water, as shown in FIG. 3A, due to the water repellency of the surface. Its cross section shows a rise at the center. A peripheral section where the thickness of electrode pattern 4 is the thinnest among other sections starts volatilizing, and other sections follow. The center section having the greatest thickness remains escaping being dried to the end. At this time, the ink in liquid condition (not dried yet) is pulled by the surface tension to the center section, thus cracks 12 and pinholes (not shown) tend to occur between the peripheral and center sections. Electrode pattern 4, where such an uneven thickness occurs, is not suitable for manufacturing electronic components of high performance required from the market.

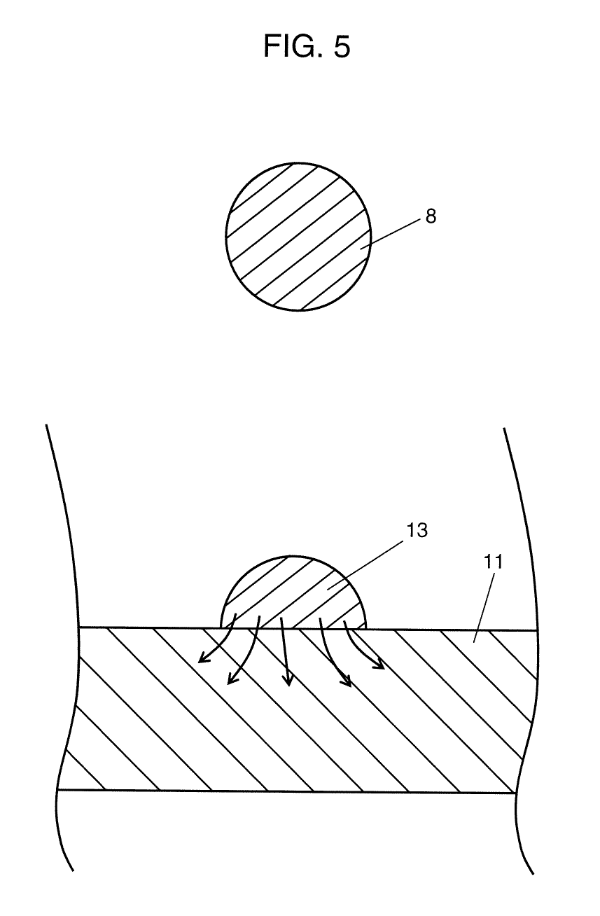

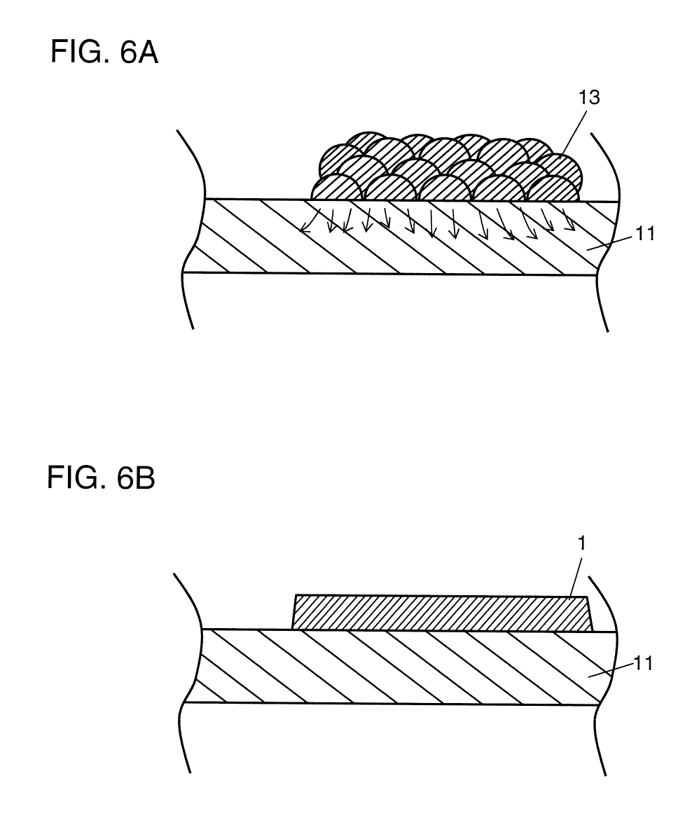

Next, a phenomenon, in which solvent component in the ink soaks into the burn-off base layer, is explained as follows: FIG. 5 and FIG. 6 illustrate that the solvent component in the ink is absorbed in the burn-off base layer thereby setting the ink. In FIG. 5, droplet 8 jetted from the inkjet apparatus (not shown) lands on burn-off base layer 11 and forms landed droplet 13. At this time, some solvent component out of droplet 8 soaks into base layer 11 along the arrow marks. FIG. 6A and FIG. 6B show a printing procedure. In actual, thousands or millions of droplets 8 per second are jetted from the inkjet apparatus (not shown), and landed droplets 13 are piled up on the sheet as shown in FIG. 6A to produce a given thickness. In this case, some solvent component from plural landed droplets 13 are absorbed into base layer 11 along the arrow marks. Landed droplets 8, from which some solvent is removed, increase their viscosity and are integrated with each other to form electrode pattern 1 shown in FIG. 6B. In a case of printing on a regular paper with the inkjet, the ink is completely absorbed into the paper because the ink is dye ink. However, according to the exemplary embodiment, ink including powder material is used and the sheet has low absorption of ink. In such a case, a highly accurate pattern is obtainable only after the burn-off base layer is formed, which is proposed by the exemplary embodiment.

### Exemplary Embodiment 3

In the foregoing second embodiment, reducing uneven thickness using burn-off base layer 11 is described. In this third embodiment, uneven thickness of an applied film is further reduced using chemical reaction between burn-off base layer 11 and ink. In this embodiment, the burn-off base layer contains organic carboxylic acid.

First, as the material of burn-off base layer 11, employ anionic polyvinyl alcohol resin (manufactured by KURARE Inc.), and dissolve the resin in pure water. Then apply the resin dissolved in the pure water onto ceramic green sheet 3 such that a thickness of dried resin becomes 0.5 micron. Burn-off base layer 11 of anion resin is thus formed.

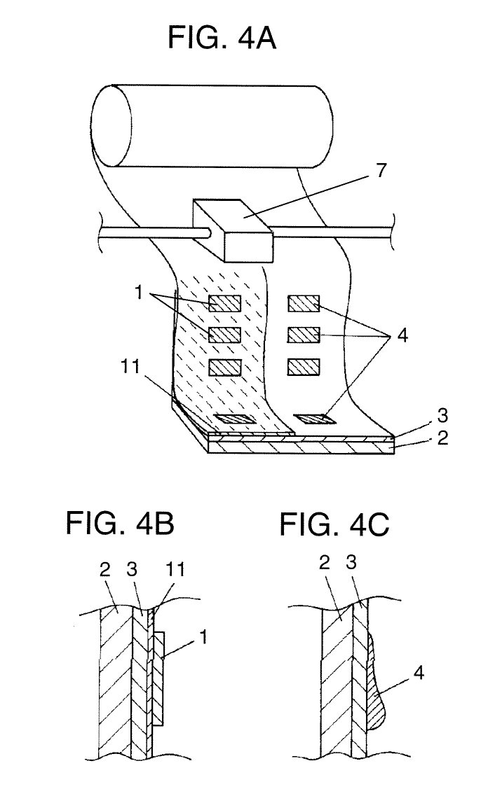

Next, as the material of ink, dissolve nonionic polyvinyl alcohol resin manufactured by KURARE Inc. in pure water. Then add some nonionic dispersant, nonionic plasticizer (glycerin, polyethylene glycol are used) and Ni powder to the resin dissolved in the pure water. Nonionic ink is thus produced. Load the nonionic ink into a printer (made by EPSON Inc., model No. MJ510C) and print patterns in 720 dpi. FIG. 4 illustrates this printing. In FIG. 4C, the ceramic green sheet on which electrodes are printed is discharged from the printer in a slanted manner, so that the ink flows in the electrode pattern and uneven print tends to occur.

In this third embodiment, electrode pattern 1 is formed on burn-off base layer 11; however, uneven print due to the ink flow does not occur. Because at the instant when nonionic ink lands on anionic burn-off base layer 11, a kind of gelling reaction between nonion component in the ink and anionic base layer 11 starts, which prevents the landed ink from flowing.

This situation is detailed with reference to FIG. 4. As shown in FIG. 4A, burn-off base layer 11 is formed on the left half of ceramic green sheet 3, on which electrode patterns are to be printed. Inkjet apparatus 7 prints given electrode patterns on sheet 3 at both the areas, one has base layer 11 and the other does not have. FIG. 4B shows electrode pattern 1 printed on burn-off base layer 11, where the ink does not drain although sheet 3 is held vertically with the ink still wet. In other words, non-uniform thickness does not occur. FIG. 4C, on the other hand, shows a status without burn-off base layer 11, where the ink of the patterns drains downward when sheet 3 is held vertically with the ink still wet.

In the case of using the burn-off base layer made of nonionic resin, the same material as the ink, the ink is formed accurately; however, a pattern formation by the inkjet apparatus onto the base layer causes the ink to drain in the pattern as shown in FIG. 4C. This phenomenon occurs when an electrode pattern still wet is placed vertically as shown in FIG. 4A or the ink is jetted onto the sheet vertically held. Then the ink drains in the pattern due to its own weight or non-uniform thickness occurs in the pattern. On the other hand, in the case of using the burn-off base layer made of anionic resin, a pattern formation on to the base layer does not cause the ink to drain in the pattern or non-uniform thickness does not occur in the pattern, although an electrode pattern still wet is placed vertically or the ink is jetted onto the sheet vertically held.

According to the exemplary embodiment, reaction between a component included in the burn-off base layer reacts and a component included in the ink allows the pattern formed on the base layer to keep its shape accurately before the solvent component volatilizes. In other words, even if the wet ink landed on the burn-off base layer is put in a drier and blown by volume hot air at a high speed, the printed pattern or its cross sectional shape is not adversely affected. Thus the manufacturing method of the exemplary embodiment allows a drier to be placed in conjunction with the inkjet apparatus, and this structure can save the manufacturing equipment a lot of space.

A use of the advantage of the exemplary embodiment in commercially available and high-speed inkjet printers, which employ various high-speed heads, allows jet-ink used for various electronic components to be dried free from adverse influence to their cross sectional shapes. The advantage is applicable in a high speed printing such as several meters per minute or several-hundred meters per minute. Since the exemplary embodiment can print electrode patterns free from uneven thickness on a sheet held vertically, a floor space for the printing apparatus can be reduced, and the printing apparatus can be integrated into another apparatus with ease. This advantage allows simplifying the apparatus, lowering the cost, and providing a clean room with ease. As a result, finished products can be manufactured at a reasonable cost and the yield ratio can be improved.

As discussed above, the material added to the ink and the material added to burn-off base layer 11 contact with each other to start gelling reaction, thereby curing the ink instantaneously. High strength of cured ink is not required in this curing reaction, but soft curing or gelling that can prevent the ink from draining is good enough. A combination of the two materials is, e.g., anionic material with nonionic material, anionic material with cationic material, nonionic material with cationic material. Reactions between those materials are described as a reaction between a donor and an acceptor in the fourth embodiment and onward.

The exemplary embodiment finds that the dispersant can be used for starting the gelling reaction. For instance, polycarboxylic acid based dispersant of anionic material, made by KAO inc. or SUN-NOPCO and available in the market, is used for producing ink, and nonionic resin is used as the burn-off base layer. In this case, a similar reaction to what is discussed above can be expected. This chemical reaction is considered similar to the gelling reaction proper to water-soluble resin, i.e., the gelling reaction between polyvinyl-alcohol-based synthetic starch available in the market being mixed with borax. Materials such as borax containing sodium or boric acid leave residual component, which affects reliability of the electronic component, after the material is baked. Therefore those materials are not good for burn-off base layer 11 of the exemplary embodiment.

It is desirable to use organic acid or organic base which does not produce residual component after the baking for realizing the manufacturing method of the exemplary embodiment. Several ten thousands of such organic substances are known in the world, and an ordinarily skilled person in the organic chemistry can optimize those materials with ease. According to the experiments by the inventors, an organic acid which includes at least carboxyl group (—COOH) is useful from the view point of reliability.

Resin including carboxylic acid is used as either one of the ink or the burn-off base layer, and resin or organic substance of cationic or nonionic one is used as the other one (base layer or ink), whereby the gelling reaction can be produced. Any organic compound R—COOH having carboxyl group can be the resin containing carboxylic acid where R represents hydrocarbon group and can be used for the exemplary embodiment.

This reaction is considered similar to a kind of salt out reaction. In the exemplary embodiment, in the case of producing metal salt, such as sodium, of alkaline material or alkaline earth material, residuals after the baking sometimes affect adversely to reliability. Thus addition compound of organic base and acid, or organic substance is preferably produced instead of metal salt from the salt out reaction.

Besides ceramic member in the burn-off base layer, conductive powder or magnetic powder can be added, so that the base layer becomes more functional. For instance, the materials proposed here to be used in the burn-off base layer can be added to the ceramic slurry which is the material of a ceramic green sheet or an unbaked ceramic member. In other words, the material supposed to react on the ink is added to the ceramic green sheet or unbaked ceramic member in advance, so that a ceramic green sheet having higher ink-acceptability can be produced.

In the exemplary embodiment, the ink preferably has a viscosity of less than 2 poise. In the case of viscosity not less than 2 poise, an inkjet apparatus available in the market clogs sometimes with the ink. The best way to prevent the inkjet apparatus from clogging is to dilute the ink with water-soluble solvent such as water or glycol; however, the thinner ink tends to produce uneven print on the sheet. The manufacturing method of the exemplary embodiment uses chemical reaction between the sheet and the ink, therefore, even if the ink is diluted, uneven print can be suppressed, and the ink can be dried fast.

### Exemplary Embodiment 4

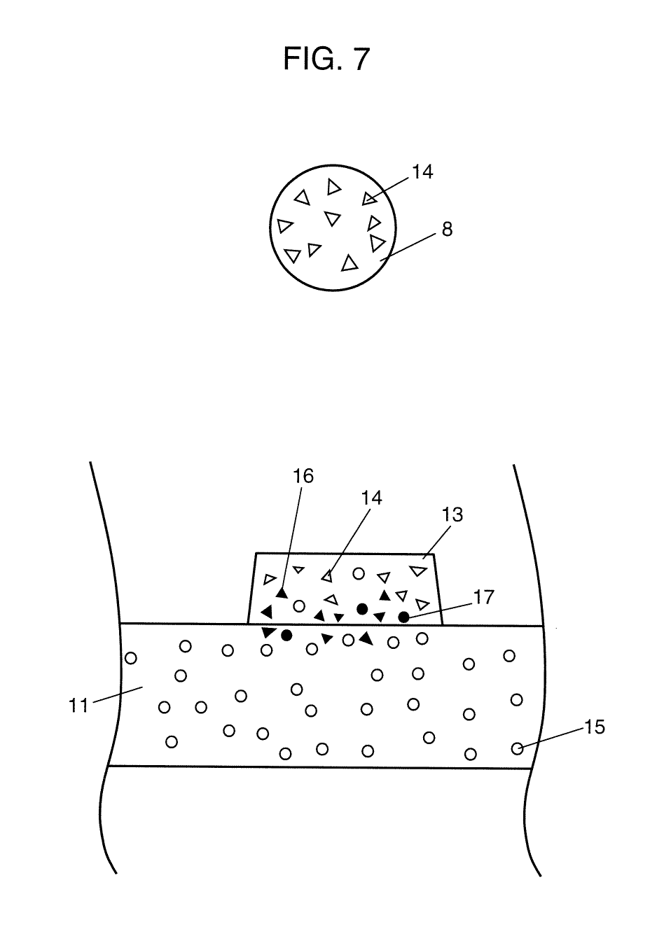

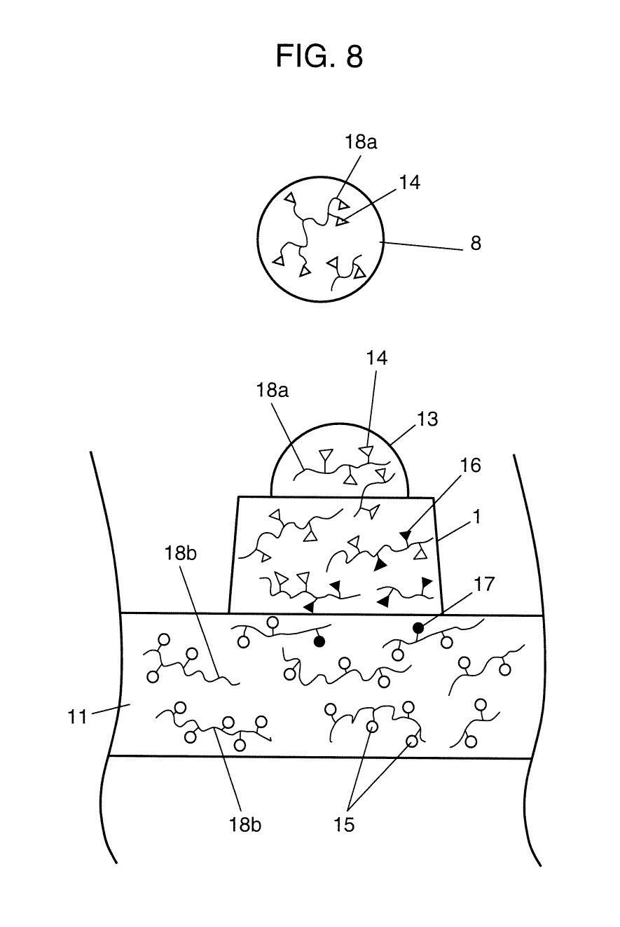

In this fourth embodiment, the gelling reaction, produced by landing the jet-ink on the burn-off base layer, is described with reference to FIGS. 7 and 8. As shown in FIG. 7, reactive members are added to the ink and the base layer in advance. The reactive member in the ink and that in the base layer contact with each other to start gelling reaction, thereby setting the ink. The ink forming droplet 8 includes in advance donor 14 corresponding to the reactive member, and base layer 11 includes in advance acceptor 15 corresponding to the reactive member. In the case of FIG. 7, droplet 8 including donor 14 lands on base layer 11 which includes acceptor 15, then donor 14 and acceptor 15 react with each other, which produces reacted donor 16 and reacted acceptor 17. Reacted donor 16 and reacted acceptor 17 start gelling the ink. As shown in FIG. 7, after the gelling, there still remain unreacted donors 14 and unreacted accpetors 15 in landed droplet 13. Those unreacted donors 14 and acceptors 15 remained in the droplet 13 can increase the thickness, volume, amount and weight of landed droplet 13 as shown in FIG. 6.

Next, the theory of reducing uneven print is demonstrated with reference to FIG. 8, which illustrates a case where a reaction between organic components is used. In this fourth embodiment, an organic component added to the ink and an organic component added in advance to the base layer react with each other, which starts gelling and sets the ink. In FIG. 8, among organic substance 18 such as resin or dispersant, resin 18a included in droplet 8 contains donor 14 as a functional group. Organic substance 18b included in base layer 11 contains acceptor 15 as a functional group. In this embodiment, droplet 8 lands on burn-off base layer 11 to form landed droplet 13. Then donor 14 of resin 18a in droplet 13 and acceptor 15 of organic substance 18b in base layer 11 produce gelling reaction.

### Exemplary Embodiment 5

In the fifth embodiment, plural inks are used, i.e., one jet-ink containing non-burn-off material (hereinafter called non-burn-off ink) and another jet-ink containing burn-off material (hereinafter called burn-off ink). A given pattern is printed on one base using the non-burn-off ink and the burn-off ink alternately. This operation is repeated plural times to form a three-dimensional structure. According to the exemplary embodiment, the members reactive with each other (e.g., donor and acceptor) are added to the non-burn-off ink and the burn-off ink respectively, so that the inks start gelling upon contacting with each other, which eliminates a step of drying the inks. Thus the inks do not mix with each other and are free from draining or oozing, and can form a given three dimensional structure. The structure thus formed is dried and baked, whereby the part formed by the burn-off ink is burnt off and volatilized. The non-burn-off material in the non-burn-off ink contained in the three dimensional structure remains as it is and is sintered to form the given structure.

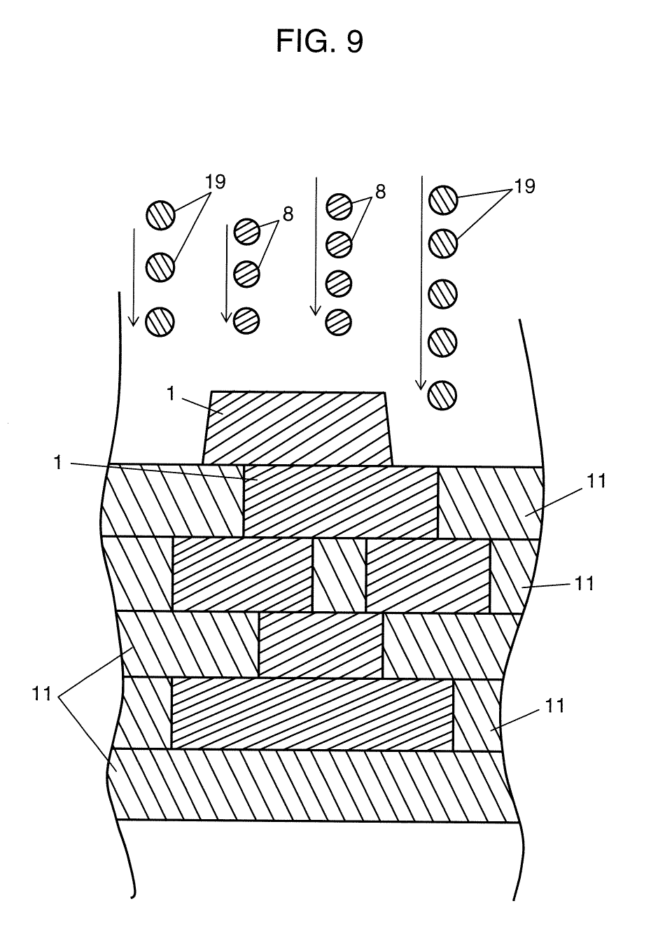

FIG. 9 illustrates a case where a reactive member is added to the jet-ink to form a three dimensional structure. In FIG. 9, droplets 19 to the base layer form burn-off layer 11 after the landing. Droplets 8 jetted from the inkjet apparatus (not shown) land and form electrode pattern 1. Droplets 19 jetted from the inkjet apparatus also land and form burn-off base layer 11. In this embodiment, droplets 8 and droplets 19 contact with each other after the landing and start gelling as discussed in the previous embodiments, therefore, the patterns do not ooze to each other. On top of the patterns thus gelled, new patterns are further formed, as shown in FIG. 9, with droplets 8 and 19 jetted from the inkjet apparatus, thereby forming a three dimensional structure. The structure thus formed is finally dried and baked, so that the part formed by droplets 8 remains as the three dimensional structure and the part formed by droplets 19 is burnt off. The three dimensional structure can be thus manufactured. Particularly in this embodiment, just before the baking, burn-off base layer 11 as a protective member protects the three dimensional structure until it is baked. The three dimensional structure can be also formed being buried in the base layer. Therefore if more complicated and elaborate work is required in a three dimensional structure, this method can manufacture it precisely and in accurate dimensions.

The baking of a three dimensional structure sometimes causes burning shrinkage in the structure by 10 to 50% depending on a baking condition. In such a case, the three dimensional CAD pattern is revised responsive to the shrinkage ratio. Particularly in this embodiment, molds are not used, and three dimensional structure can be directly formed by the inkjet. Thus only a change of dimension in the three dimensional CAD can revise a burning shrinkage ratio, so that a highly accurate structure can be formed in a short time.

Material hard to be sintered such as ceramic members including alumina or zirconia can be added to the burn-off base layer, so that a three dimensional structure is not loosen or deformed during the baking.

### Exemplary Embodiment 6

In the sixth embodiment, non-burn-off materials different from each other are put respectively into different inks reactive with each other, and a given pattern is formed on a single base using these inks. This operation is repeated plural times to form a three dimensional structure. Particularly in this embodiment, reactive members with each other are put in the respective inks, so that the inks still wet do not mix with each other and are free from draining or oozing. As a result, a three dimensional structure still wet or in gel status can be formed. The three dimensional structure thus formed is dried and baked, whereby the three dimensional structure made of the non-burn-off materials different from each other is formed.

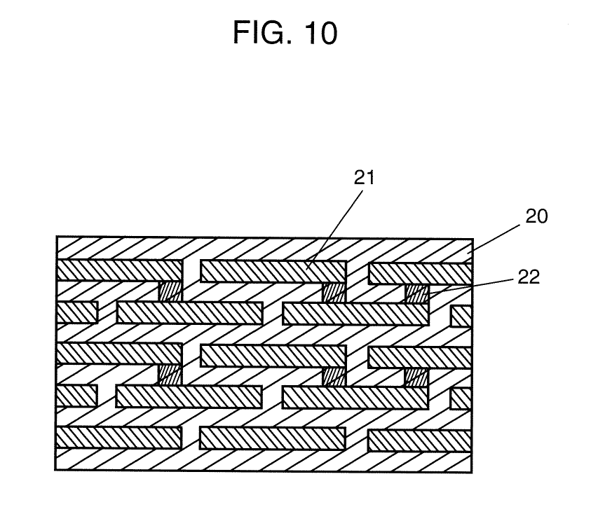

FIG. 10 shows a sectional view of the three dimensional electronic component produced in accordance with the sixth embodiment. As shown in FIG. 10, ink (not shown) for ceramic lands and forms ceramic 20, ink (not shown) for electrode lands and forms electrode 21, and ink (not shown) for via hole lands and forms via hole 22. The three dimensional structure thus formed is then baked at a given temperature, and external electrodes are formed before it is completed as a given electronic component. In the sixth embodiment, donors or acceptors are added individually to the respective inks for ceramic, electrode and via hole. Thus those inks are gelled to avoid mixing with each other, and a required printed structure can be formed.

As the ink for forming ceramic 20, the following materials such as glass, dielectric body, magnetic body, or ceramic can be used as far as they are oxide.

### Exemplary Embodiment 7

In the seventh embodiment, the reactive member is described, which is to be used for forming a three dimensional structure using ink and burn-off base layer, or plural inks. In this embodiment, donors are added to ink and acceptors are added to the burn-off base layer. The donor and acceptor are reactive with each other. At the moment when the ink including the donors lands on the base layer which includes the acceptors, the donors and acceptors react with each other. Thus the landed ink is prevented from draining. As a matter of course, when the ink contains acceptors and the burn-off base layer contains donors, draining of the ink is also prevented. In this embodiment, for the purpose of simple description, the reactive member contained in the ink jetted from a printer head is called donor, and the reactive member contained in the ink accepting side is called acceptor.

### Exemplary Embodiment 8

In the eighth embodiment, a salting out member is used in donors and acceptors that produce gelling reaction. First, anionic PVA is dissolved in water, and this water solution is applied and dried as a burn-off base layer of anionic material. To be more specific, PVA is modified by carboxylic group, meanwhile this member is purchased from KURARE Inc. The ink is made of a given powder with additive of nonionic or cationic material. Then an inkjet apparatus jets the ink onto the base layer of anionic material to form a given pattern. At the instant when the ink lands on the base layer, the ink reacts on anionic resin of the base layer and starts gelling. In this case, the water solution of anionic PVA is made of commercial anionic PVA in a quantity of 1 to 50 g, dissolved in the pure water of 100 g. If the amount of PVA is less than 1 g, the concentration of resin solution is too low and a necessary film thickness sometimes cannot be obtained. If the amount of PVA is not less than 50 g, the viscosity of the resin solution is too high and it is hard to apply the solution. In the case of thinning the base layer thickness not more than 0.1 micron, or increasing the thickness of the ink not less than 10 micron, the absolute amount of the anionic resin contained in the base layer eventually becomes small, which lowers reactivity with the ink. In such a case, organic acid can be added to the anionic base layer, thereby strengthening the gelling reaction. For instance, dissolve anionic PVA available in the market of 1 g to 40 g into pure water of 100 g, and dissolve organic acid such as citric acid or lactic acid of 0.1 g to 10 g therein. The water solution thus produced is applied and dried to be the burn-off base layer. Other than anionic resin, formic acid, acetic acid, oxalic acid, citric acid and lactic acid can be used as organic acid. One of those organic acids only or combined with other water-soluble resin can produce a similar reaction. An effective amount to be added is 0.1 g to 10 g. A molecular weight of the organic acid is preferably 100 or more than 100. If the molecular weight is less than 100, the organic acid added to the base layer sometimes volatilizes and disappears automatically. If the organic acid is added to the anionic PVA, it sometimes causes gelling reaction to the PVA instead. To prevent this problem, it is preferable to add weak organic acid to weak acid water-soluble resin. Strong acid and weak acid are classified based on functional groups, and relevant literatures available in the market tell the classification.

As anionic materials, it is preferable to select the material including functional group such as NH—, OH—, CO₃—, HCO₃—, CH₃CO₂—, and the like. Dispersant, resin of phosphoric acid base, S—, HS—, or HSO₄— tends to attach to powder surface, and they are very useful as additive to the ink because those materials can increase dispersion and stability of the ink. Be cautious that an amount of those additive is preferably less than 1 g because too much additive would damage the oven during the baking or degrade the reliability of the product.

In the case of using water-soluble resin as burn-off base layer 11, the following materials can be used: polyvinyl acetal resin, polyvinyl alcohol resin, methyl cellulose resin, carboxy-methyl cellulose resin, hydroxy-propyl cellulose resin, and acrylic resin. The resins discussed above are added to one of jet-ink or the base layer, and organic acid or organic base is added to the other one, thereby producing the gelling reaction.

When metals such as nickel, in particular, is used in ink with resin or dispersant of carboxylic acid, the ink thus produced becomes weak acid, and nickel sometimes dissolves as ion to form supernatant liquid (nickel ion) of blue-green color. If the ink's pH is greater than 3, nickel dissolves a little and no serious problem occurs; however, if the pH is not more than 3 (particularly not more than 2), the nickel dissolves a lot, which degrades the properties of a laminated ceramic capacitor having an internal electrode made of nickel.

### Exemplary Embodiment 9

In the ninth embodiment, a combination of acceptors and donors employs the members that cause gelling reaction. The difference in pH of a burn-off base layer from that of jet-ink is used to produce gelling reaction. For instance, first one uses acid of less than pH 7 and second one uses base of pH 7 or greater than pH 7, and acid-base reaction can be used. In a case of using an acid substance or a basic substance having a small molecular weight, gelling reaction does not occur and the ink stays water-soluble status. On the contrary, in a case of using the substance having a great molecular weight, e.g., more than 1000, neutralization reaction between the acid and base lowers the dissoluble concentration of that substance. Thus the substance cannot be hydrated completely, and parts of the substance separates out (deposits) in gelled status in the solvent. Meanwhile, a pH meter available in the market tells whether the ink or base layer is acidic, basic or neutral. Ink per se is set in a centrifugal separator, and fine particles in the ink precipitate, the supernatant liquid thus obtained can be used for measuring pH. To know the pH of the burn-off base layer, dip the base layer into pure water, and put it in a centrifugal separator to obtain supernatant liquid, which is used for measuring the pH. The super-natant liquid thus obtained can be concentrated upon request.

The inventors find that the difference in pH of the burn-off base layer from that of the jet-ink is preferably not less than 0.5 (more preferably not less than 1). When the difference in pH is not less than 0.5, polymeric materials, of which molecular weight is at least 1000, preferably more than several thousands or more than several ten thousands, can cause gelling reaction because of the difference of acid and base of their functional groups.

### Exemplary Embodiment 10

In the tenth embodiment, a combination of acceptors and donors employs the members that cause chemical reaction. A selection of acidic or neutral burn-off base layer with respect to basic ink causes similar chemical reaction to what is discussed in the previous embodiments. For instance, dispersant including amino group or cationic dispersant is mixed into the ink to produce basic ink. Basic water-soluble organic solvent of various aminesor dimethyl formanide (DMF) can be added to this ink, so that dispersibility and stability of the ink improve and also reactivity of the base layer increases.

Next, the case where amine is used as basic material is detailed hereinafter. Amine or amide used in one of the ink or the burn-off base layer can cause gelling reaction similar to that discussed in the previous embodiments. Meanwhile primary amine refers to RNH₂, secondary amine refers to R₂NH, and tertiary amine refers to R₃N. Any amines can be used in the exemplary embodiment. R represents hydrocarbon. As for amide, any amide of primary amide, secondary amide and tertiary amide can be used in the exemplary embodiment. For instance, ethanol amine can be used in either one of the ink or the base layer. Gelling reaction can starts when a basic material is used in either one of the ink or the base layer. In any cases, it is preferable to use pH not more than 12. If pH is 12 or more than 12, human skin can be corroded depending on handling the materials.

### Exemplary Embodiment 11

In the eleventh embodiment, a combination of acceptors and donors utilizes solidifying reaction of protein. The exemplary embodiment can utilize the solidifying reaction of protein. This reaction has been used in manufacturing “tofu” (bean curd). In the exemplary embodiment, simple protein such as albumin and globulin, or gelatin, peptone, keratin, collagen can be used as protein.

Various proteins are available at a reasonable cost due to the recent progress of biochemistry, and proteins excellent in absorption to powder surface or binder component in ink are also available. In other words, protein component is mixed with ink, and setting agent such as gluconic acid is mixed with the burn-off base layer, so that the ink starts solidifying upon contacting of the ink and the base layer.

Further, biochemical aggregation, similar to the foregoing reaction and one of antigen-antibody reactions, can be used. This reaction refers to a phenomenon where hematid (red blood cell) in blood aggregates due to antibody reaction to antigen. In this embodiment, antigen or antibody bonded to the surface of synthetic resin particles can be used instead of putting hematid in the ink, so that high sensitivity of arregation is utilized. Thus a very little amount of such material can be useful in the exemplary embodiment. Such materials are available at reasonable costs thanks to the recent progress of biochemistry Materials excellent in absorption to powder surface or binder component in ink are also available.

### Exemplary Embodiment 12

In the twelfth embodiment, a combination of acceptors and donors produces dehydrating reaction. Methanol, ethanol or other higher alcohol or acetone can be added in advance as dehydrating agent to burn-off base layer 11 in order to gel the ink mixed with water-soluble resin such as polyvinyl alcohol. At the instance when this water-soluble ink lands on base layer 11 including the dehydrating agent, the water component in the ink is removed and parts of the hydrated ink materials separate out (deposit) or thicken (body up). Thus the landed ink can keep its shape accurately. The reaction between the burn-off base layer and the ink proposed in the exemplary embodiment can be satisfied with accompanying the gelling or the increase of viscosity. Therefore, milk commercially available can be used in the ink, and vinegar commercially available can be used in the burn-off base layer. It is generally known that when milk mixes with vinegar, the milk is gelled. In this case, the component emulsified and dispersed in the milk is broken. The exemplary embodiment can utilize such agglutination reaction of emulsion.

### Exemplary Embodiment 13

In the thirteenth embodiment, non-water-soluble resin is emulsified in water, and this resin is used instead of water-soluble resin. For instance, non-water-soluble resin such as polyvinyl-butyral is emulsified in the water with emulsifying agent. This product is commercially available. Such emulsifying results in a nonionic product, a cationic product or an anionic product depending on an emulsifying agent. A use of polarity difference in those emulsions thus obtained can cause gelling reaction similar to those discussed in the previous embodiments. For instance, when nonionic emulsion is mixed with anionic emulsion, the emulsions are broken and resin component separates out into the water solution. This kind of gelling reaction or separating reaction can be produced by, e.g., adding organic acid, organic base, or water-soluble anionic resin or cationic resin to nonionic emulsion.

Therefore, one of the emulsions discussed above is added to either one of the ink or the burn-off base layer, and the material reactive to this emulsion is added to the other one (ink or base layer), so that setting reaction or solidifying reaction occurs in colloid solution. Those reactions (gelling, separation of resin, increasing viscosity, precipitation) make an ink-shape printed by inkjet more precisely.

In a case of using latex resin or emulsion resin in burn-off base layer 11, a particle diameter of those materials is preferably not more than 5 microns (more preferably not more than 2 microns). If emulsion particles having diameter of not less than 5 microns are used in the ink, the printer head tends to clog, and when the particles are used in the base layer, they cause uneven thickness of the base layer. Thus the particle diameter not less than 5 microns is not suitable for manufacturing electronic components.

As discussed above, non-water-soluble resin can be used in the exemplary embodiment, namely, water-soluble resin such as polyvinyl alcohol is used as emulsifying agent or protective agent to form emulsion. Anionic material containing carboxyl group can be used as emulsifying agent, so that anionic emulsion resin is produced. The anionic emulsion resin thus produced induces a kind of gelling reaction upon contacting with cationic resin or organic base, cationic emulsion or nonionic resin.

A use of emulsion reduces amount of organic solvent used in the manufacturing process of ink or burn-off base layer. Therefore, in the manufacturing site, safe and environmental friendly manufacturing free from fire regulation can be realized.

### Exemplary Embodiment 14

In the fourteenth embodiment, physical gel is used as the donor and acceptor of the exemplary embodiment. The physical gel in this embodiment refers to the gel formed by physical bridge such as hydrogen bonding or ionic bonding between polymer molecules, or chelate formation. Such gels can be produced by varying heat, types of solvents, ion concentration, or pH. The water solution of agar or gelatin is turned into gel by lowering the temperature, and turned into sol by raising the temperature. Such a reversible gelling reaction can be used in the exemplary embodiment.

As discussed above, two types of polymer electrolytic solutions having opposite electric charges to each other are mixed, thereby producing gel called polyion complex gel. Such a gel is subjected to various factors including types of solvents, ion concentration, pH, polymer concentration and the like; however, optimization of those parameters produces a structure that can maintain more precise three dimensional shape. For instance, polycation and polyanion in an equal quantity are added to the ink and the burn-off base layer respectively, thereby producing neutral gel in the landed ink.

Polycarboxylic acid such as polyacrylic acid or strong acid polymer such as polyst_{y}rene sulfonic acid) is bonded with alkaline-earth metal, thereby also synthesizing gel. Such bonds is not a direct bond between metallic ion and ligand, but the bond is formed via hydration-ion, therefore, gelled ink is obtainable with ease. In those reactions, optimization of molecular weight and concentration of polymer, types of solvents, salt concentration can produce a suitable set condition of the ink for respective applications.

The gels such as agar, gelatin, agarose, alginic acid, carrageenan and the like are the products of sol-gel reaction due to their helix formations. In those cases, the ink made of gelatin water solution is heated and jetted from an inkjet apparatus to a cooled sheet, then the landed ink can be set. In a case of gelatin, it is practically useful because its sol-gel transformation tends to occur around 25° C. In a case of electrolytic polysaccharide such as alginic acid, adding calcium ion helps producing gel. Thus polysaccharide or calcium can be added to either one of the ink or the burn-off base layer, or vice versa can make the ink set suitable for respective applications. In a case of calcium, it hardly affects adversely to the finished product even the calcium is baked. Agar and agarose can be also used.

In the exemplary embodiment, the gelling indicates a status where fluidity of ink lowers. For instance, a combination of protogenic polymer such as polyacrylic acid, polyaryl amine, polyvinyl alcohol, with protophilic polymer such as polyethylene glycol, polyvinyl pyrrolidone can produce gel. In a case of using such polymer gel or polymer complex, the percentage composition of the protogenic polymer and protophilic polymer can be adjusted as approx. 1:1, so that stable gelling reaction is expected. Optimization of polymer concentration, ion concentration, and pH upon request can realize the ink-set condition suitable for the request.

In a case of polymer having ligand, which can form complex as side chain, such as poly(carboxylic acid), polyol and polyamine, adding polyvalent metal ion can help producing ion. For instance, polyvinyl alcohol in copper acetate aqueous solution is used as the burn-off base layer, and the ink including NH₃ functional group lands on this base layer. Then the landed ink becomes gel instantaneously. Reaction of hydro-colloid such as alginate, mannan with bivalent metal ion such as calcium ion also produces gel. In a case of such gel, chelator such as ethylene diamine tetra-acetate (EDTA) is added so that calcium ion is removed, whereby the gel turns into sol again. Arbitrary control of this gelling-soling reaction can optimize manufacturing methods of various electronic components suitable for respective applications and products.

Xanthan gum of polysaccharide, which is used as bodying agent or gelling agent in food, can be used in this application of the exemplary embodiment. Hyaluronic acid can be also used in this application because of its high water absorbing property. Curdlan of polysaccharide is not water-soluble but can be gelled at 54° C. and, at 80° C. it is further gelled thermally irreversible, thus it can be used in this application. As discussed above, in the case of natural polymer, various gelling reactions are available. For instance, starch, agar, carageenan, and gelatin can be gelled by hydrogen bonding (gelling by cooling in particular). Adding polyvalent metal ion to alginic acid, pectin, carboxymethyl cellulose, or mannan can produce gel. Methyl cellulose or hydroxy-propyl cellulose can be gelled by its hydrophobic interaction (gelled by heating, e.g., alkyl side-chain of carbon number 6, 12, 16 is added in a quantity of several % to hydroxy-propyl cellulose, then gelling reaction occurs). Xanthan gum or hyaluronic acid can be gelled by cooling. Curdlan can be gelled by heating. Those reactions can be used in the exemplary embodiment. Hyaluronic acid made by cosmetic manufacturers or food manufactures in Japan is available. They manufacture this acid by fermentation method or extract it from cock's comb.

In a case of protein, gelatin or collagen can be gelled by cooling. Egg white albumin, soybean protein or casein can be gelled by heating (or protein association). Fibrin, elastin or keratin is possibly gelled by covalent bond. Those gelling reaction can be also used in the exemplary embodiment.

Various materials developed for disposal diapers, sanitary napkins, skincare, and hair-care can be also used. Polymer aggregating agent (electrolytic polymer that aggregates fine particles dispersing in water) can be used in the burn-off base layer, so that fine particles of the metal or the oxide contained in the ink landed on the base layer can be flucculated or precipitated for setting the ink. For such an application, nonion or anion polymer, cationic polymer and amphoteric polymer are commercially available. They can be used in the exemplary embodiment responsive to respective applications.

The jet-ink used in the exemplary embodiment preferably contains at least one of metal powder, dielectric powder, glass powder, ceramic powder, ferrite powder, oxide powder in a quantity of 1 to 80 weight %. If the content is less than 1 weight %, a predetermined electrical properties sometimes cannot be obtained after baking. If the content is not less than 81 weight %, ink sometimes clogs the inkjet printer. A particle diameter of those powder is preferably ranges from 0.001 μm to 10 μm. If the diameter is less than 0.001 μm, pieces of powder become too small, which invites a higher cost, and sometimes a given electrical property cannot be obtained. If the diameter is not less than 12 μm, the powder percipitates or flucculates in the jet-printer, which eventually clogs. The viscosity of jet-ink is preferably not more than 2 poise. If the viscosity is not less than 2.5 poise, a jet printer is hard to jet the ink, and jets the ink in dispersed directions. In a case of jetting the ink in dispersed directions, landing accuracy of the ink on the sheet degrades, so that the inkjet cannot form a precise pattern.

Reactive material or organic material containing functional groups such as carboxylic acid, carboxyl group or amine, they are to be donors or acceptors proposed by the exemplary embodiment, is preferably contained in the ink or the burn-off base layer in a quantity of not less than 0.01 weight %. If the content is less than 0.01 weight %, the ink set status required in the exemplary embodiment sometimes cannot be obtained.

When the burn-off base layer is to disappear, the thickness is preferably not more than 20 μm. If the thickness is not less than 25 μm, the pattern formed on the base layer slips or deforms when the base layer disappears. In the case of reaction produced by difference in pH, the difference is preferably not less than 0.5. If the difference is less than 0.3, the landed ink sometimes cannot be gelled.

The gelling reaction proposed in the exemplary embodiment is a phenomenon occurs between plural jet-inks, or jet-ink and a burn-off base layer, or jet-ink and a substrate supposed to be printed. The gel per se is preferably an organic substance to be burnt off. However, as discussed above, metal, oxide, or metal ion thereof contained in the jet ink or the burn-off base layer reacts with another organic substance after the landing, and they can be gelled.

Thus, in accordance with the exemplary embodiment, an ink pattern can be formed also on the surfaces of low ink acceptability with least oozing and dripping. The low ink acceptability surfaces of metal sheet, etc. can be provided with a high-precision ink pattern using the method of exemplary embodiment. Furthermore, an ink pattern can be formed on the surfaces of cylindrical substance and other three-dimensional items with least oozing and dripping.

The ink pattern provided in accordance with the exemplary embodiment is a pattern in gel state produced as the result of reaction between the base layer and the jet-ink ink landed on the base layer. Therefore, the pattern in gel state can be used also as the resist pattern (including the resist pattern for etching) employed in the manufacturing of electronic components. Various types of electronic components may be made available by taking advantage of these ink patterns or resist patterns.

Now, a method of manufacturing electronic components is described in accordance with the fifteenth exemplary embodiment.

### Exemplary Embodiment 15

A method of manufacturing a magnet roll used in printers which make use of toner is described in the fifteenth exemplary embodiment. Magnet roll is an electronic component; it is also called development roll, development sleeve, and toner carrier.

In the recent laser printer business, users demand the printed image of improved quality. Conventional printers use magnet rolls made of metal pipe having sand-blasted surface. The conventional magnet rolls, however, are machined on the surface of the metal pipe with cutting and the like devices to be finished to a high dimensional accuracy, and then the surface is roughened by sand-blasting to provide a roughness for the sake of improved toner holding. Such being the conventional situation, a magnet roll of the higher mechanical precision level that does not employ sand-blasting process has been requested.

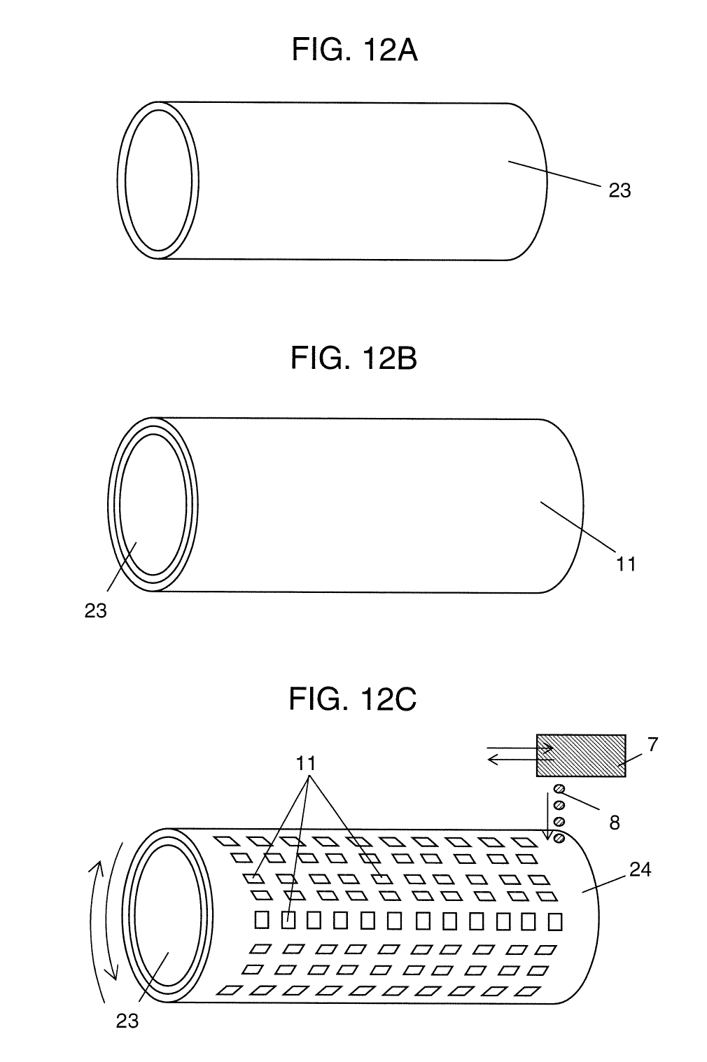

An exemplary method of manufacturing a magnet roll is described in accordance with the exemplary embodiment, referring to FIG. 12 through FIG. 14.

FIGS. 12A, 12B and 12C are perspective views showing how a resist pattern is formed on the surface of a metal pipe. In FIG. 12A, reference numeral 23 indicates a metal pipe, of which the mechanical precision level has been raised through the cutting, grinding, etc.

FIG. 12B is a perspective view showing metal pipe 23 coated at the surface with base layer 11. Base layer 11 can be provided by means of dip coating, inkjet printing, spraying, etc.

FIG. 12C shows how a pattern is printed on base layer 11 by droplets 8 jetted from inkjet apparatus 7. Droplets 8 form a certain resist pattern 24 after they landed on base layer 11.

As the arrow marks in FIG. 12C indicate, inkjet apparatus 7 and metal pipe 23 moves respectively. Resist pattern 24 is formed on the entire surface of metal pipe 23 by shifting inkjet apparatus 7 to and fro, while revolving metal pipe 23, in the respective directions as indicated with arrow marks. The traveling distance of inkjet apparatus 7 and the revolution angle of metal pipe 23 may be determined to an optimum according to respective applications.

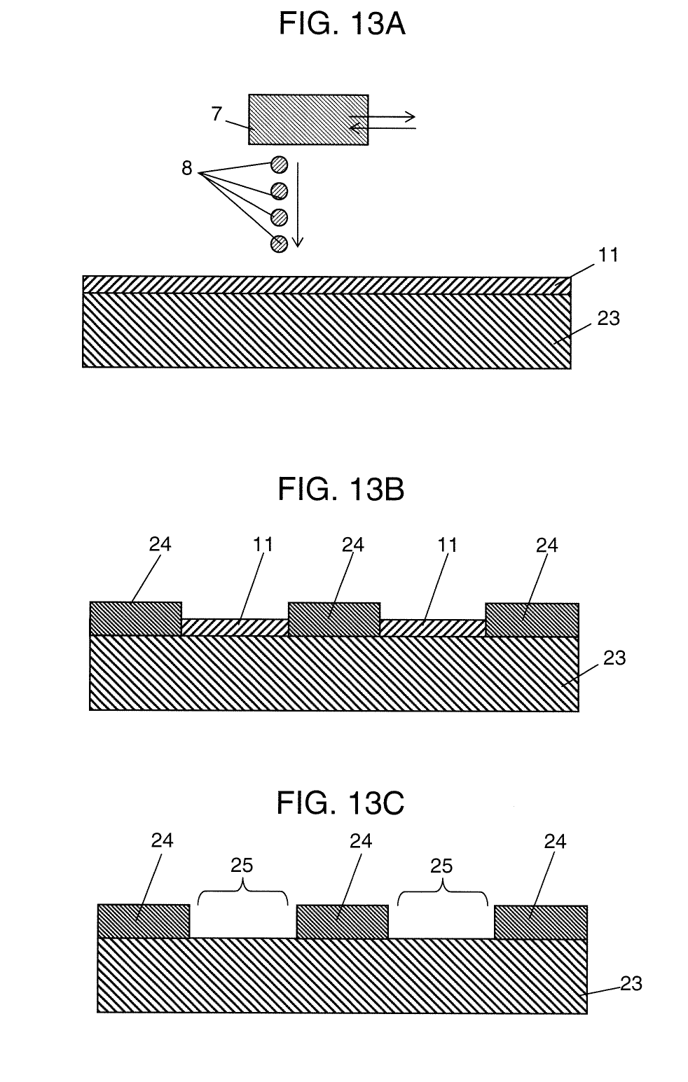

Now, detailed description is made referring to FIG. 13.

FIGS. 13 A, 13B and 13C are cross sectional views showing how resist pattern 24 is formed on the surface of metal pipe 23. FIG. 13A shows how inkjet apparatus 7 jets droplets 8 for the printing.

FIG. 13B shows how droplet 8 jetted from inkjet apparatus 7 lands on base layer 11 to form resist pattern 24. FIG. 13B corresponds to a cross section of FIG. 12C.

FIG. 13C shows the state after base layer 11 is removed. In FIG. 13C, reference numeral 25 indicates an opening, at the bottom of opening 25 the surface of metal pipe 23 is exposed uncovered. When metal pipe 23 of FIG. 13B is washed with water, for example, non-gelled part of base layer 11 is selectively removed. Opening 25 is thus provided. Resist pattern 24 is created by gelling reaction between landed droplet 8 and base layer 11, and resist pattern 24 is not removed.

Resist pattern 24 is a gelled compound of droplet 8 and base layer 11. Instead, resist pattern 24 may be formed with either a mixture of droplet 8 and base layer 11, or a compatible blend material of droplet 8 and base layer 11. Or, the resist pattern may be formed of a substance created by gelling reaction caused after these mixture and compatible blend material were heated. It is useful to heat resist pattern 24. Heat treatment reinforces the film strength of resist pattern 24 and the withstanding property against etching solution.

Now, description is made on a case where resist pattern 24 is formed by compatible blending base layer 11 and droplet 8 landed on base layer 11 together, or mixing them, and then heating them to cause the gelling. An alkaline water-soluble resin of copolymerized isobutylene and maleic anhydride can be used for a compound which brings droplet 8 and base layer 11 into a chemical reaction or mutual reaction to cause the gelling. The alkaline water-soluble resin can be made into water-soluble state by having it reacted with sodium hydroxide, ammonia-ammine, etc. Alkaline water-soluble resin is an organic substance that burns-off by baking at a temperature not lower than 300° C.

First, as shown in FIG. 12B, base layer 11 of water-soluble resin is formed on the surface of metal pipe 23. Next, as shown in FIG. 12C, a water-soluble ink containing alkaline water-soluble resin is ejected onto the base layer from inkjet apparatus 7 in the form of droplet 8. In this way, resist pattern 24 made of a compatible blend substance, or a mixture, of base layer 11 and droplet 8 is formed on the surface of metal pipe 23. The resist pattern 24 becomes insoluble after it underwent a heat treatment not lower than 120° C. This is caused because; as the result of heat treatment, the alkaline water-soluble resin and alcohol group, ammine group, epoxy group contained in the water-soluble resin of base layer 11 react to cause gelling, or becomes insoluble.

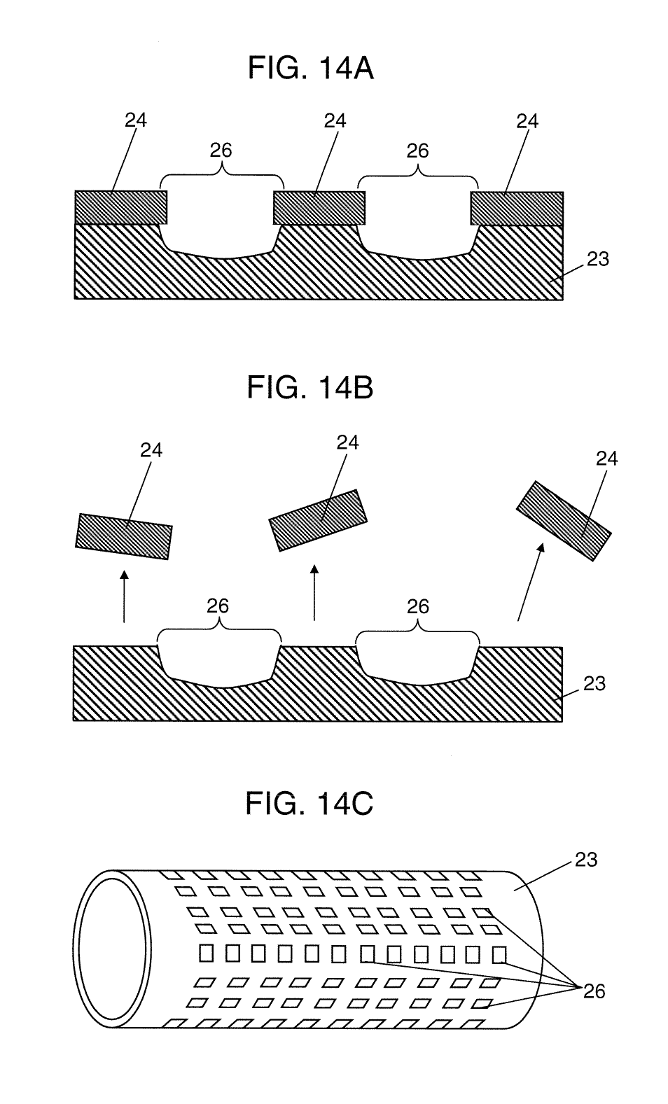

FIGS. 14A, 14B and 14C are cross sectional views and perspective view used to show how the surface of metal pipe 23 is etched with resist pattern 24 used as the etching resist.

FIG. 14A is a cross sectional view which shows a state after the surface of metal pipe 23 is etched with resist pattern 24 used as the etching resist. In FIG. 14A, reference numeral 26 indicates a recess created as the result of etching of surface of metal pipe 23.

FIG. 14B is a cross sectional view showing how resist pattern 24 is removed. Resist pattern 24 can be removed by immersing it in warm water of approximately 60° C. through 90° C., or by applying a high pressure jet of warm water. For the purpose of removing resist pattern 24, a rubbing operation using a resin-made brush, etc. may be useful.

FIG. 14C is a perspective view of metal pipe 23 provided on the surface with recesses 26 having a specific pattern. By inserting a specific magnetic member at the central part or other place in the inside of metal pipe 23, a magnet roll is completed to be incorporated in a printer.

### Exemplary Embodiment 16

In the sixteenth exemplary embodiment, description is made on the improvement in the quality of images printed with a magnet roll of fifteenth exemplary embodiment revolving at high speed.

In the recent laser printers, users demand higher printing speed. For this purpose, amount of toner transfer per unit time by a fast revolving magnet roll has to be increased. However, recesses 26 of conventional sand-blasted magnet rolls have smooth inner wall surface. So, toner sometimes slips on the smooth surface of the inner wall of recess 26. When the magnet roll is driven at a high revolution speed, the amount of toner transfer per unit time sometimes decreases.

Therefore, a magnet roll which does not allow the toner to make slipping on the inner wall surface of recess 26 even when it is revolving at high speed has been requested.

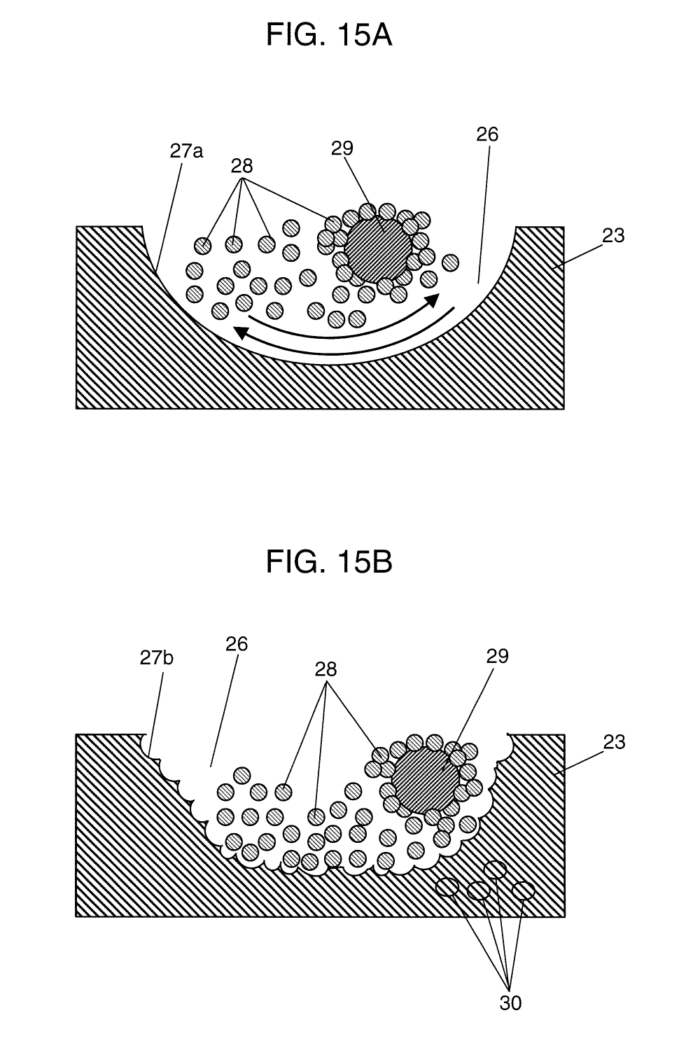

FIGS. 15A and 15B illustrate how toner slips on the inner wall surface of recess 26, and how to prevent it.

FIG. 15A is a cross sectional view of recess 26 used to show how toner and the carrier slip on the smooth inner wall surface. FIG. 15B is a cross sectional view used to describe how toner and the carrier are held retained without slipping on the roughened inner wall surface of recess 26.

In FIG. 15A, reference numeral 27a indicates the inner wall surface having a smooth surface (or smooth inner wall surface 27a). Reference numeral 28 indicates toner and reference numeral 29 indicates a carrier. Toner 28 is as small as several microns in the diameter. So, toner 28 and carrier 29 sometimes slip on the smooth surface of inner wall 27a along the directions of arrow marks.

FIG. 15B shows how roughened inner wall surface 27b of recess 26 (or arranging inner wall surface 27b to have an irregularity) prevents toner 28 and carrier 29 from making slippage. In FIG. 15B, inner wall surface 27b of recess 26 is provided with irregularities that each correspond to grain diameter of toner 28. Toner 28 in FIG. 15B is hooked by the irregularity of inner wall surface 27b matching the grain diameter of toner 28; so, the slipping is curbed.

In order to form the irregularity matching the grain diameter of toner 28 on inner wall surface 27b of recess 26, it is preferred to take advantage of grain boundary 30 of an alloy (e.g., aluminum alloy) constituting metal pipe 23. By choosing an aluminum alloy whose grain boundary 30 corresponds to the size of the grain diameter of toner 28, an irregularity that corresponds to the grain size of toner 28 can be formed evenly covering substantially the entire area of inner wall surface 27b.

Preferred average grain diameter for toner 28 is several microns (more preferably, not smaller than 1 micron and not larger than 20 microns; further preferably, not smaller than 2 microns and not larger than 10 microns). Further preference in this case is that the average grain diameter of grain boundary 30 falls within a range not lower than 10% and not higher than 500% of average grain diameter of toner 28. If it goes outside the above-described range, the anti-slipping effects might deteriorate.

Thus, the slipping of toner 28 can be avoided by taking inter-relationship between the average grain size of grain boundary 30 and the average grain size of toner 28 into consideration. Irregularity where a protrusion relevant to grain boundary 30 is effectively pushing up on inner wall surface 27b can be provided by electrolytic etching process. The electrolytic etching can form an irregularity making use of the differences in the electro-conductivity and the etching speed arising from grain boundary 30.

The irregularity on inner wall surface 27b should ideally be consisted of recesses formed after grain boundary 30 fell off as the result of etching, or protrusions formed of grain boundary 30, or a combination of the above recesses and protrusions.

The size of carrier 29 may be greater than that of grain boundary 30. This is because; toner 28 sticking on the surface of carrier 29 is hooked by protrusion of grain boundary 30 protruding on the inner wall surface 27b.

As to an etching solution for the electrolytic etching, it is economical to use a water solution of hydrochloric acid (not lower than 1 wt % and not higher than 10 wt %). If the concentration of hydrochloric acid is lower than 1 wt %, it takes too much time for etching metal pipe 23. If the concentration of hydrochloric acid is higher than 10 wt %, it will need a special care for handling. As to a material for metal pipe 23, AL (aluminum) is preferred to SUS (stainless steel). In some cases, SUS pipe would face difficulties in forming recess 26 by etching, or in providing a protrusion of grain boundary 30 protruding on inner wall surface 27b.

It is preferred that metal material of metal pipe 23 be an aluminum alloy which contains at least silicon in a quantity of not less than 0.20% and not more than 0.60%, or magnesium in a quantity of not less than 0.45% and not more than 0.90%. Or, an aluminum alloy which contains at least silicon in a quantity of not less than 0.20% and not more than 0.60%, in addition, magnesium in a quantity of not less than 0.45% and not more than 0.90%, may be used. The latter aluminum alloy facilitates a higher precision level machining after machining it with cutting or grinding tools. Also, controlling the size of grain boundary 30 to be within a range of 5 through 30 microns will become easier with the latter alloy. The element used for the control of grain boundary 30 is not limited to magnesium and silicon. Instead, it may be controlled by adding iron, chromium, titanium or the like metal components.

Thus, silicon, magnesium, iron, chromium, titanium and the like metal component other than aluminum is separated out to grain boundary 30. By making part of these metal components other than aluminum to separate out actively on inner wall surface 27b, the function of retaining toner 28 from slipping will be ensured.

### Exemplary Embodiment 17

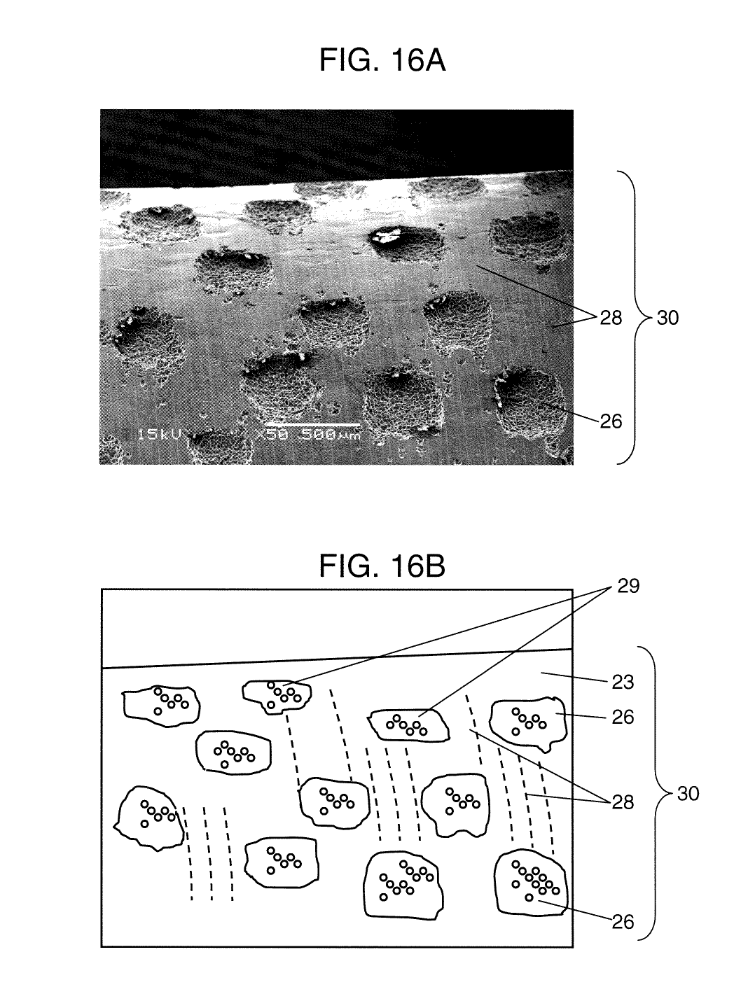

In the seventeenth exemplary embodiment, a description will be given of a surface of a magnet roll according to the exemplary embodiment with reference to FIG. 16A and FIG. 16B. FIG. 16A is an electron micrograph showing an enlarged view of a part of a surface of a magnet roll according to the exemplary embodiment, and FIG. 16B is a schematic diagram used for explaining the electron micrograph of FIG. 16A.

The magnet roll according to the exemplary embodiment is used in a laser beam printer or the like, and is used for carrying toner for development together with carrier to a portion of a latent image. The magnet roll according to the exemplary embodiment includes a metallic roll having recesses formed, on a surface thereof, in a pattern (e.g., linear pattern, point-like pattern, polka-dot pattern, checkered pattern, or the like) for carrying the toner or the like and a magnet provided in the roll.

As illustrated in FIG. 16A and FIG. 16B, magnet roll 30 according to the exemplary embodiment has a plurality of recesses 26 on a surface thereof.

It is understood from FIG. 16A and FIG. 16B that machine processing marks 28 in a spiral shape are formed in a circumferential direction with a regular pitch on the surface of magnet roll 30 according to the exemplary embodiment. In addition, a plurality of recesses 26 with, for example, a rectangular shape are formed on the surface of magnet roll 30. Further, irregularity aggregation surface 29 formed of a plurality of irregularities for preventing slippage is formed on an inner wall of recess 26.

Irregularity aggregation surface 29 formed on the surface of the inner wall of recess 26 is formed of irregularities (these are illustrated as irregularity aggregation surface 29 in the drawings) produced by grain boundaries resulted from etching of grains of metal forming magnet roll 30. The grain boundaries are exposed on the inner wall of the recess as a result of etching and form irregularity aggregation surface 29. By forming the irregularities produced by the grain boundaries as irregularity aggregation surface 29 on an entire surface of the inner wall of recess 26, toner 28 and carrier 29 (both of them are not illustrated) are prevented from slipping in recess 26, as illustrated in FIG. 15B.

As illustrated in FIG. 16A and FIG. 16B, it is preferable that the roll surface of magnet roll 30 excluding recesses 26 maintain an original metal surface. Maintaining the original metal surface means that parts of polishing textures (or polishing marks) or cutting textures (cutting marks) which are caused when a metal roll is polished or cut are left as processing marks 28 on the metal surface. As illustrated in FIG. 16A and FIG. 16B, coexistence of the original metal surface and recesses 26 makes it possible to prolong the life of magnet roll 30. As a result, processing marks 28 are maintained on the original metal surface.

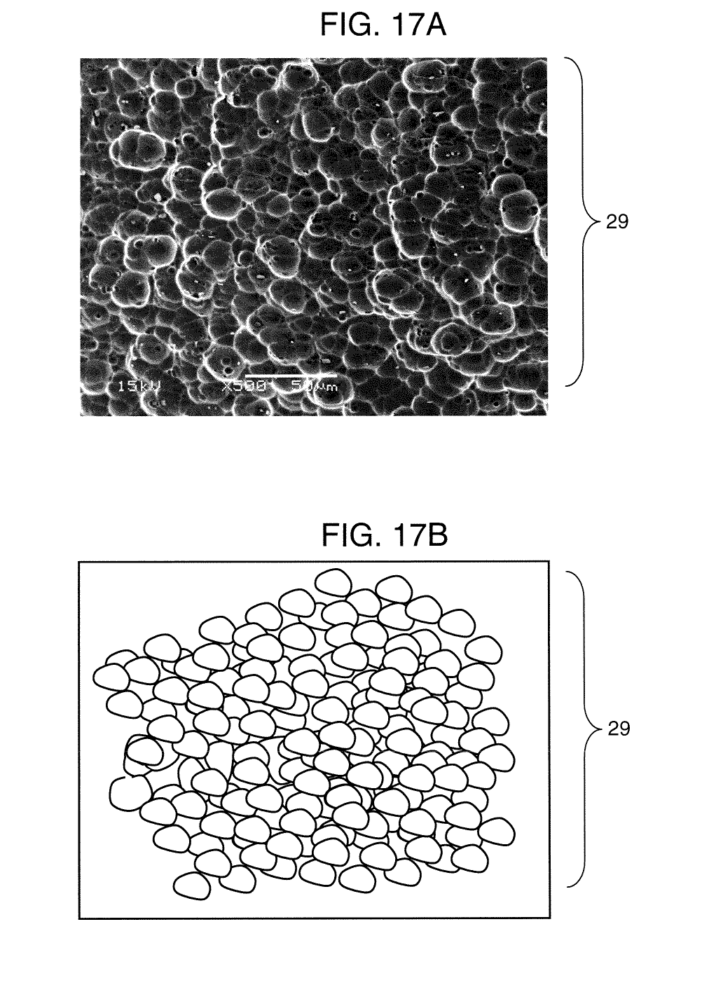

Next, irregularity aggregation surface 29 will be described with reference to FIG. 17A and FIG. 17B. FIG. 17A is an electron micrograph of the surface of the inner wall of the recess formed on the surface of the magnet roll according to the exemplary embodiment, and FIG. 17B is a schematic diagram used for explaining the electron micrograph of FIG. 17A.

As shown in FIG. 17A and FIG. 17B, irregularity aggregation surface 29 including a countless number of irregularities is pushed up on the surface of the inner wall of recess 26. As described with reference to FIG. 16B, inner wall surface 27b (or irregularity inner surface 27b) forming irregularity aggregation surface 29 provides an effect of preventing slippage of toner 28 and carrier 29 (both of them are not illustrated).

As shown in FIG. 17A and FIG. 17B, irregularity aggregation surface 29 formed of protrusions, recesses, or combinations thereof having different large and small sizes is formed on a substantially entire surface of the inner wall of recess 26. The individual recesses and protrusions exposed on irregularity aggregation surface 29 have circular or spherical shapes, and it is desirable that an average diameter thereof be 1 μm or larger and 30 μm (preferably 20 μm) or smaller. Further, it is desirable that individual recesses and protrusions have large and small, and a plurality of different sizes. By arranging them in such a shape or a distribution, it is possible to enhance the effect of preventing the slippage of toner 28 and carrier 29 (both of them are not illustrated) which enter into recess 26 even when magnet roll 30 is rotated at a high speed. Accordingly, in the case of a printer using the magnet roll according to the exemplary embodiment, even when the printer is used for a long time or in high-speed printing, an amount of transfer of toner 28 per unit time does not drop, and therefore an excellent printing quality can be maintained.

In FIG. 17A, a magnification is 500 times (×500), and a white line in the picture is 50 μm long. From FIG. 17a, it is understood that irregularity aggregation surface 29 formed of protrusions, recesses, or combinations thereof having different large and small sizes is formed on a substantially entire surface of the inner wall of recess 26.

A density of the individual irregularities formed on irregularity aggregation surface 29 may be adjusted according to an application of the magnet roll. However, it is preferable to provide 5 or more irregularities, and it is more preferable to provide 10 or more irregularities in an area of at least 100 μm by 100 μm. If the number of irregularities in the area of 100 μm by 100 μm is smaller than 5, there are some cases where the effect of preventing slippage becomes low.

It is preferable that sizes of the individual irregularities forming irregularity aggregation surface 29 be in a range of an average diameter between 1 μm and 30 μm (preferably 20 μm) regardless of the density thereof. Then, as shown in FIG. 17A and FIG. 17B, by arranging a multiple number of large and small irregularities in an overlapping manner and many irregularities in an overlapping manner, it is possible to further prevent the slippage. In this way, by arranging a shape or a distribution with a multiple number of irregularities having large and small, and different sizes, it is difficult for toner 28 and carrier 29 entered into recesses 26 to slip in recesses 26 even when magnet roll 30 is rotated at a high speed. As a result, in the case of the high speed printing of the printer, an amount of transfer of toner 28 per unit time does not drop, and therefore a printing quality becomes stable.

In addition to this, an effect of preventing slippage is enhanced by setting the average grain diameter of irregularity aggregation surfaces 29 to 20% or more and 400% or less of the average grain diameter of the toner.

Particularly, in recent years, toner 28 having a smaller size has been often used for achieving high printing quality. Toner 28 having such smaller size itself has a small tap density, and therefore is difficult to handle. Further, toner 28 is easy to slip on magnet roll 30. However, as shown in FIG. 15B, FIG. 16A, FIG. 16B, FIG. 17A, and FIG. 17B, by pushing up irregularity aggregation surface 29 corresponding to the grain size of toner 28 on the entire surface of the inner wall of recess 26, it is possible to prevent slippage of toner 28. Here, the average grain diameter of toner 28 is assumed as an average grain diameter of a primary particle of toner 28. This means that, when the primary particle of toner 28 is hooked by the surface or the like of irregularity aggregation surface 29 which is pushed up, a secondary particle of toner 28 can be transferred.

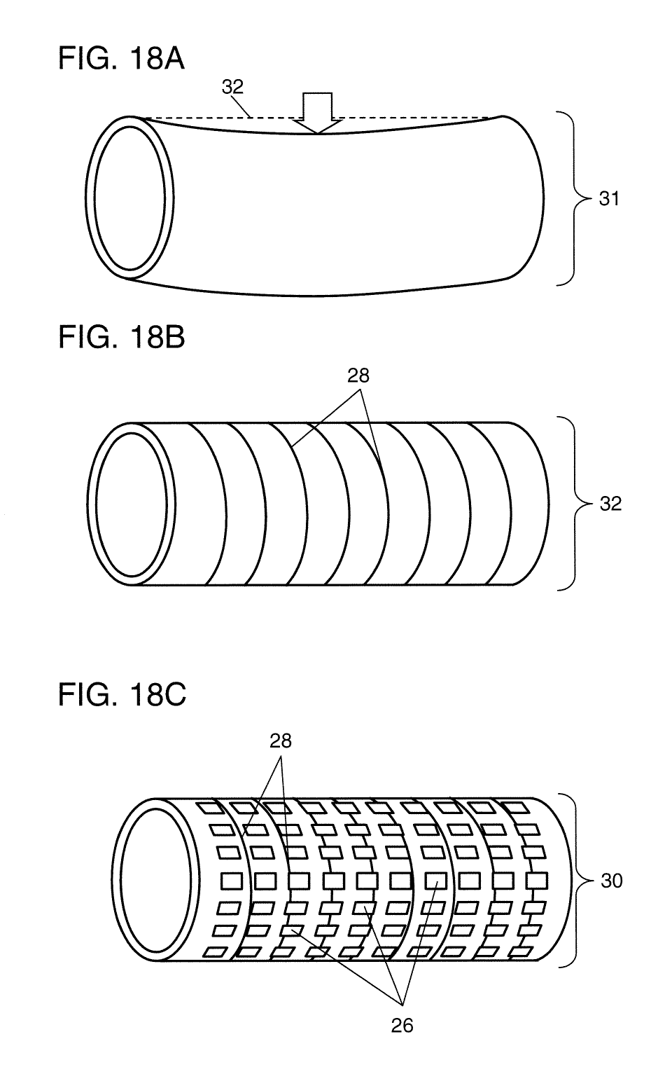

FIG. 18A is a perspective view illustrating a state before machine processing marks are provided on the surface of the magnet roll, FIG. 18B is a perspective view illustrating a state with the processing marks, and FIG. 18C is a perspective view illustrating a state with the processing marks and recesses provided on the surface of the magnet roll according to the exemplary embodiment.

Referring to FIG. 18A, ordinary low-precision metal pipe 31 (e.g., a pipe made of an aluminum alloy or the like having a diameter ranging between about 10 mm and 30 mm and a length ranging between about 20 cm and 50 cm) has poor roundness, poor parallelism, poor straightness (edge-runout), or the like, and therefore is often distorted or bent as shown by an arrow with respect to a reference surface indicated by a dotted line. Such distortion or bend sometimes affects a quality of magnet roll 30, and therefore is removed by cutting, polishing, or the like machining process as illustrated in FIG. 18B.

FIG. 18B illustrates a state in which a surface or the like of low-precision metal pipe 31 is processed to high-precision metal pipe 32 by polishing, cutting, or the like. Further, in this process, it is preferable to leave polishing textures in the case of polishing or cutting textures in the case of cutting on a metal surface as processing marks 28 so that a part or more than a part of the textures is left. By actively providing processing marks 28, adherence of burn-off base layer 11 is enhanced, as illustrated in FIG. 12B. Thereafter, the processes as illustrated in FIG. 12B to FIG. 14B are performed, and a state illustrated in FIG. 18C is made by providing recesses 28 on the surface of high-precision metal pipe 32.

FIG. 18C is a perspective view illustrating the magnet roll according to the exemplary embodiment. As illustrated in FIG. 18C, magnet roll 30 according to the exemplary embodiment has a plurality of processing marks 28 and a plurality of recesses 26 on the surface thereof. In this way, it is preferable that the original metal surface be maintained on the roll surface excluding the recesses of magnet roll 30.

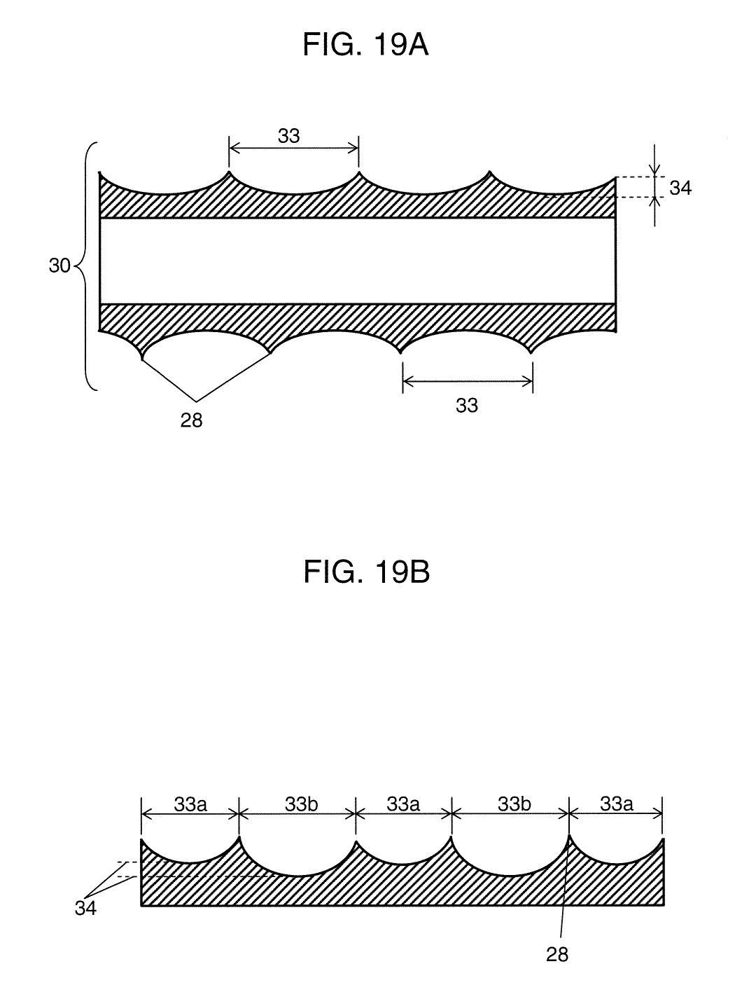

Next, referring to FIG. 19A and FIG. 19B, a shape of processing mark 28 will be described. FIG. 19A is a sectional view of the magnet roll with the processing marks. FIG. 19B is a sectional view illustrating a part of a magnet roll with a plurality of types of processing marks. FIG. 19A and FIG. 19B do not illustrate recess 26 and irregularity aggregation surface 29 provided inside recess 26. As illustrated in FIG. 19A and FIG. 19B, it is preferable that processing marks 28 be formed at substantially regular pitch 33. In addition, as illustrated in FIG. 19A, it is preferable that processing mark 28 have a certain difference in height (e.g., more than 0.5 μm, or more than 1.0 μm). Further, as illustrated in FIG. 19B, it is also useful to make an arrangement so that processing marks 28 have a combination of a plurality of pitches 33a and 33b. Furthermore, it is preferable that bottoms of the plurality of processing marks 28 have difference 34 in height.

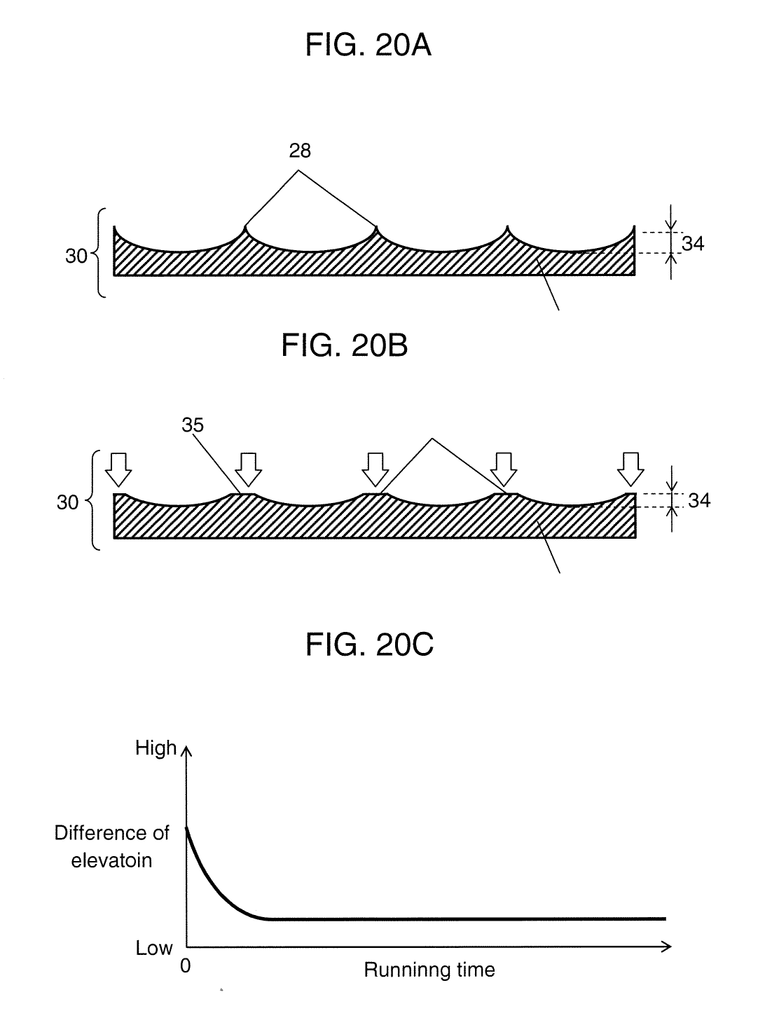

Next, with reference to FIG. 20A to FIG. 20C, a description will be given of how durability of the roll is improved by providing processing marks 28.

FIG. 20A is a sectional view illustrating an initial state of the magnet roll. Referring to FIG. 20A, the surface of magnet roll 30 is as has been processed, maintains a state of a metal surface immediately after processing, as is, and therefore has processing marks 28 formed thereon having difference 34 in height in a circumferential direction.

FIG. 20B is a sectional view of the magnet roll after a long period of use. As illustrated in FIG. 20B, processing marks 28 have difference 34 in a circumferential direction, and therefore start wearing from portions indicated by arrows to thereby form worn portions 35.

FIG. 20C illustrates how the difference of height of processing mark 28 on the surface of the magnet roll changes with a running time. In FIG. 20C, an X-axis represents a running time, and Y-axis represents a difference of height. As illustrated in FIG. 20B, since processing marks 28 of magnet roll 30 according to the exemplary embodiment are formed continuously in the circumferential direction, certain difference 34 is maintained in the circumferential direction even if the running time is prolonged, and thereby worn portion 35 becomes wider as illustrated in FIG. 20C. For this reason, even if the difference of height of magnet roll 30 according to the exemplary embodiment at an initial stage is high, difference 34 caused by processing mark 28 remains as a substantially constant value on the surface thereof even after a long-time use, and therefore paper feeding performance in the printer remains unchanged. This is because processing marks 28 are formed continuously in the circumferential direction.

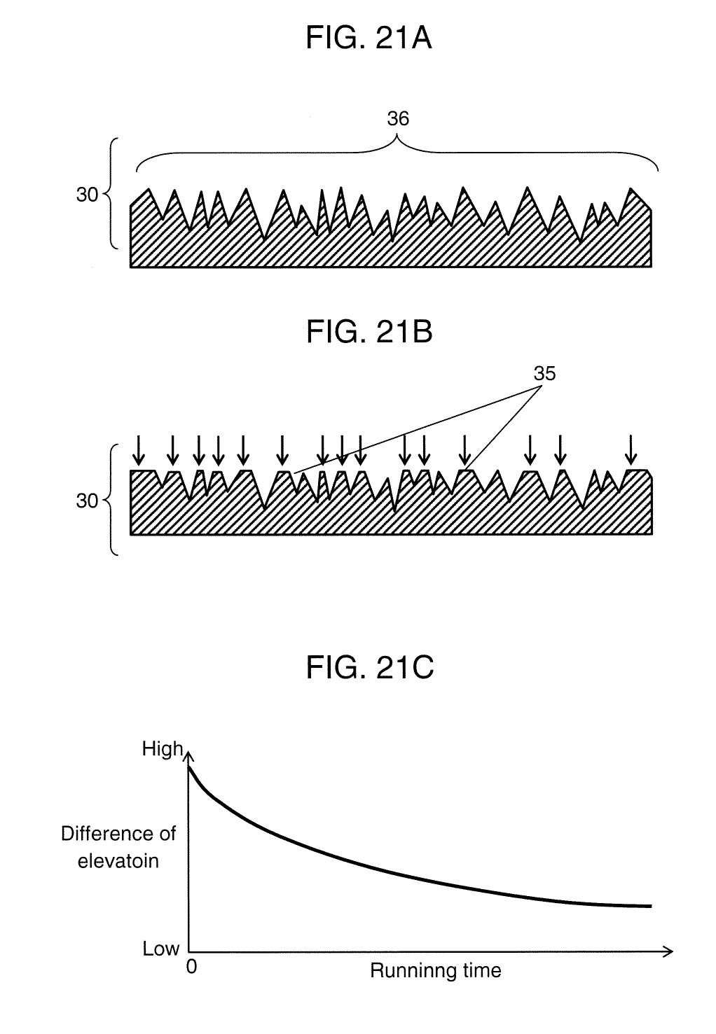

Next, with reference to FIG. 21A and FIG. 21B, a description will be given of a problem of processing marks (e.g., processing marks caused by sand-blasting or the like) having no orientation according to the conventional manufacturing method.

FIG. 21A is a sectional view illustrating an initial surface condition of a conventional magnet roll with the conventional processing marks having no orientation. FIG. 21B is a sectional view illustrating a surface condition of the conventional magnet roll with the conventional processing marks having no orientation after a long period of use. As illustrated in FIG. 21B, when a period of use is prolonged, worn portion 35 spreads, and as illustrated in FIG. 21C, difference 34 which was high in the initial stage gradually becomes low as the running time increases. As a result of this, since conventional processing mark 36 often has no orientation, difference 34 is further reduced resultantly as the running time increases, and the paper feeding performance in the printer is deteriorated. Further, since random irregularities of conventional processing marks 36 which are formed by sand-blasting have stresses remaining in the processed portions or the like, a degree of wear is hard to be stabilized, which may highly serve as a cause for variation in the paper feeding performance in the printer.

It is useful to use aluminum or an aluminum alloy to make the metal pipe used for magnet roll 30. By using aluminum or the aluminum alloy, it is possible to use an acid or alkali etching solution. This is because aluminum is an amphoteric metal. Then, by optimizing the etching solution or the etching method, irregularity aggregation surface 29 can be formed on a substantially entire surface of the inner wall of recess 26.

When the aluminum alloy is used, it is preferable that it contain at least silicon in a quantity of not less than 0.20% and not more than 0.60%.

Further, when the aluminum alloy is used, it is preferable that it contain at least silicon in a quantity of not less than 0.20% and not more than 0.60% and, at the same time, at least magnesium in a quantity of not less than 0.45% and not more than 0.90%.

It is preferable that an average size of grain boundaries of a metallic member forming magnet roll 30 be 5 μm or larger and 30 μm or smaller.

Further, it is preferable that an average size of grain boundaries of the metallic member forming magnet roll 30 be 10% or larger and 500% or smaller of a grain diameter of the toner.

It is preferable that an average diameter of carrier 29 used for magnet roll 30 be larger than the average diameter of the grain boundaries.

It is preferable that an average diameter of toner 28 used for magnet roll 30 be 1 μm or larger and 20 μm or smaller.

Etching for forming irregularity aggregation surface 29 of magnet roll 30 is preferably performed by electrolytic etching. With the electrolytic etching, it is easy to push out the irregularities caused by the grain boundaries as irregularity aggregation surface 29 on the inner wall surface of recess 26.

It is useful to arrange a hydrochloric acid water solution as an etching solution used for forming irregularity aggregation surface 29 of magnet roll 30. With the hydrochloric water solution, it is easy to expose the irregularities caused by the grain boundaries on the inner wall surface of recess 26 as irregularity aggregation surface 29.

It is preferable that the roll surface excluding recesses 26 of magnet roll 30 include processing marks 28 in the form of one or more of polishing patterns in the circumferential direction of the roll or cutting patterns in a spiral shape.

In magnet roll 30, there may be a plurality of depths of recesses 26. For example, by repeating the processes, i.e., forming the etching resist to performing etching as illustrated in FIG. 12B to FIG. 14B, it is possible to form a first group of a plurality of recesses 26a (not illustrated) having an average depth of, for example, 30 μm as described earlier, a second group of a plurality of recesses 26b (not illustrated) having an average depth of 60 μm, and a third group of a plurality of recesses 26c (not illustrated) having an average depth of 100 μm. In this way, a substantially same depth is maintained in each of the groups, but different average depths are arranged across the first to third groups. Accordingly, stability in carrying toner 28 can be improved in each of a low-speed region, a medium-speed region, and a high-speed region of the magnet roll.

Magnet roll 30 has a pipe-like shape, and it is useful to rotatably provide a magnetic body inside the pipe. As the magnetic body, it is possible use a magnet body proposed by the inventors in Japanese Patent Application Non-examined Publication No. 2002-343624 or the like.

It is preferable that the depths of recesses 26 provided on magnet roll 30 be in a range between a depth of 10 μm and a depth of 300 μm. If the average depth of recesses 26 deviates from this range, an amount of carrying toner 28 per unit time may be reduced.

This will be described in more details. For example, when aluminum or an aluminum alloy is used for magnet roll 30, it is preferable that hydrochloric acid (concentration between 1 wt % and 10 wt %) be used as an etching solution in view of cost. If the concentration is lower than 1 wt %, it takes too long for etching. If the concentration exceeds 10 wt %, careful handling is required. Further, it is also possible to perform electrolytic etching (voltage is applied during etching). In that case, it is preferable that the concentration of hydrochloric acid be between 1 wt % and 10 wt %. If the concentration is lower than 1 wt %, it takes too long for etching. If the concentration exceeds 10 wt %, careful handling is required. Further, when the electrolytic etching is performed, it is preferable that a side of a work, i.e., the roll, be arranged as an anode side. In addition, a cathode side is arranged to have a shape corresponding to a shape of the roll (e.g., cylindrical shape) so that variation in etching is subdued. A metallic material having a grain size ranging between 20% and 400% of the average grain diameter of toner 28 is used here.

It is preferable that Rmax of processing mark 28 (cutting surface or polished surface) of metal pipe 23 be smaller such as 10 μm or less. In the case where Rmax is larger than 10 μm, when a resist material (photosensitive resin, ultraviolet ray curable resin, or the like) is coated, there may be cases in which a pinhole is formed in the resist material. It is further preferable that Rmax be set to 5 μm or smaller. For example, buffing or sandblasting can be performed to reduce Rmax as small as 10 μm or smaller. According to such processing, for example, Rmax is reduced to 10 μm or smaller (preferably, 5 μm or smaller) so that an amount of bubbles of the resist material can be reduced, and an adhesion strength (or a peel strength) between the resist material and a metal pipe 23 can be increased. Here, Rmax is defined in JIS-B0601, but may be replaced with Rz (ten-point mean roughness).

Even if the initial surface roughness Rmax of magnet roll 30 is set to be 10 μm or smaller (preferably, 5 μm or smaller), the surface roughness is rapidly reduced with time, and therefore a stable printing quality can be obtained over a long period.

According to an experiment by the inventors, the surface roughness of magnet roll 31 before performing cutting or polishing is expressed by Ra=1.06 μm, Rz=7.3 μm, Ry=5.3 μm, and cylindricity is 19.52 μm.

On the other hand, in the case where magnet roll 31 is subjected to polishing processing as illustrated in FIG. 18B, and arranged as magnet roll 30 illustrated in FIG. 18C while processing marks 28 are left in the circumferential direction, the following values are obtained: Ra=0.34 μm, Rz=1.81 μm, Ry=2.40 μm, and cylindricity is 9.87 μm.

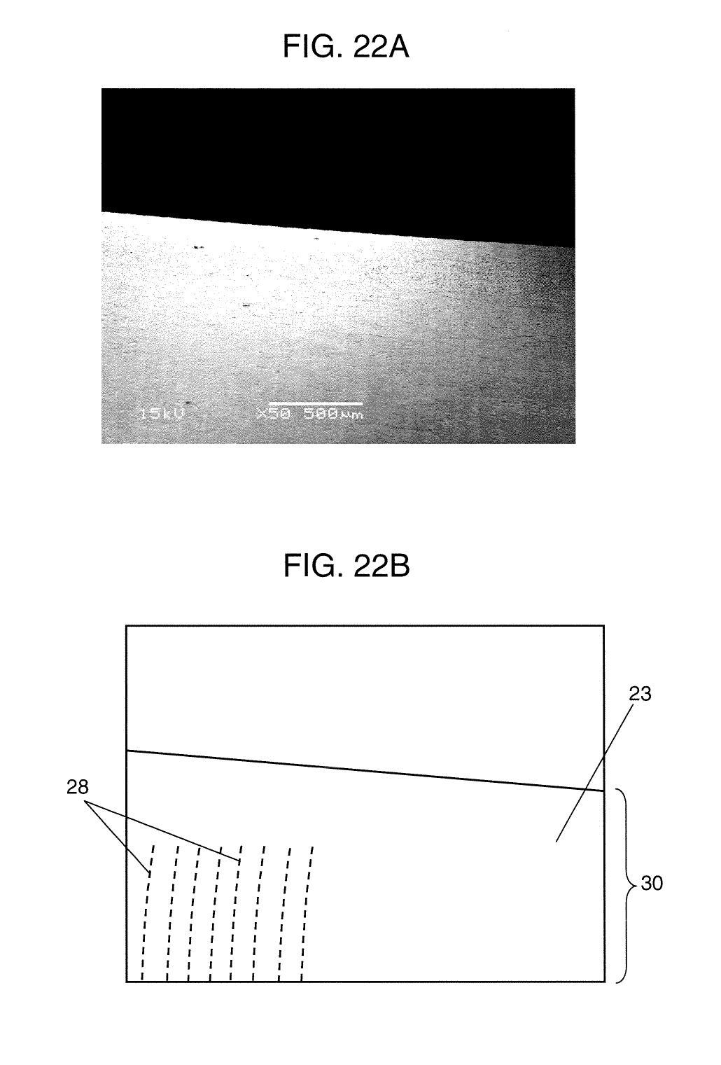

FIG. 22A is an electron micrograph of a roll surface excluding the recesses of the magnet roll according to the exemplary embodiment. FIG. 22B is a schematic diagram used for explaining FIG. 22A. As shown in FIG. 22A and FIG. 22B, the processing marks 28 are provided continuously in the circumferential direction on the surface, excluding recesses 26, of magnet roll 30 according to the exemplary embodiment.

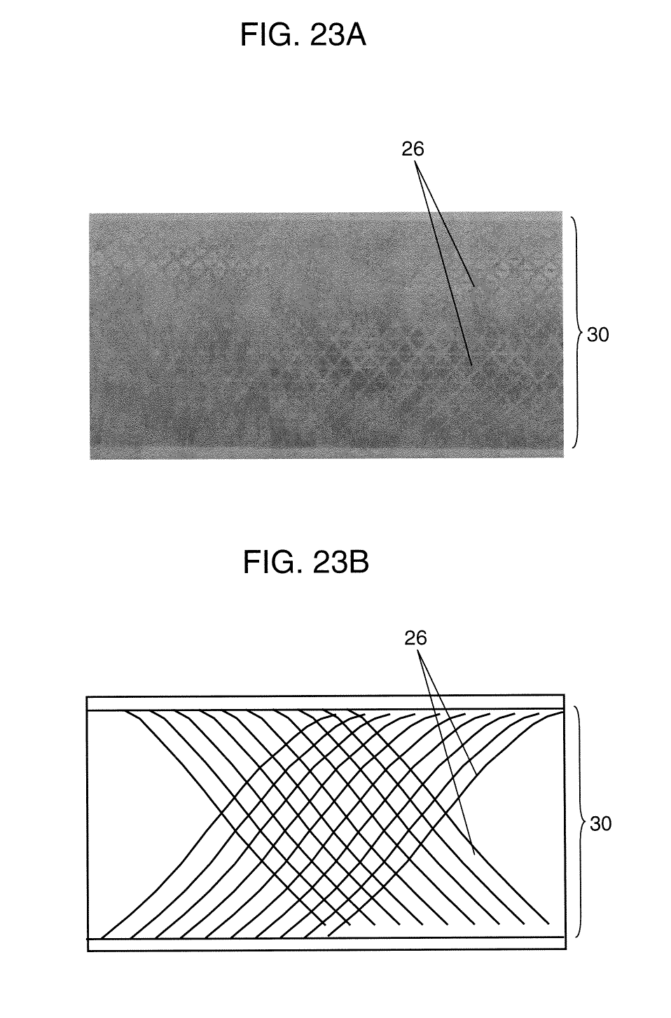

FIG. 23A is a photograph showing one example of a pattern of the recesses provided on the surface of the magnet roll according to the exemplary embodiment. FIG. 23B is a schematic diagram used for explaining FIG. 23A. As illustrated in FIG. 23A and FIG. 23B, it is also useful to form the recesses on the surface of magnet roll 30 as a continuous spiral pattern. Further, since magnet roll 30 according to the exemplary embodiment is formed by an inkjet process, it is possible to form the recesses as a continuous pattern without joints over an entire circumference of magnet roll 30.

As described above, the values of Ra, Rz, and Ry are made smaller by using a processing means such as polishing or cutting, so that the circularity and the cylindricity can be increased. Further, processing marks 28 are provided in the circumferential direction, and, additionally, processing marks 28 are purposely left on the metal surface excluding recesses 26, so that excellent paper feeding performance can be maintained as illustrated in FIG. 20B and FIG. 20C.

1. A magnet roll for carrying toner for development together with carrier to a portion of a latent image, the roll comprising:
a roll made of a metal including a patterned recesses provided on a surface of the roll; and
a magnet provided inside the roll,
wherein the recesses are produced by the steps of:
providing a base layer on the surface of the roll to make the surface of the roll to be acceptable for an ink for inkjet;
spraying the ink onto a surface of the base layer by means of an inkjet process to form a pattern that is insoluble by an etching solution for etching the metal by a gelling reaction or interaction between the base layer and the ink;
forming the recesses on the surface of the roll by etching the surface of the roll made of metal on which the pattern is formed; and
removing the pattern,
wherein a surface of an inner wall of each of the recesses includes irregularities that are generated by grain boundaries resulted from etching of grains constituting the metal,
a size of the irregularities corresponds to a grain diameter of the toner,
the irregularities are formed on an entire surface of the inner wall of each of the recesses, and
the surface of the roll excluding the recesses maintains an original metal surface.

2. The magnet roll according to claim 1,
wherein the metal is an aluminum alloy.

3. The magnet roll according to claim 2,
wherein the aluminum alloy contains at least silicon in a quantity of not less than 0.20 wt % and not more than 0.60 wt %.

4. The magnet roll according to claim 3,
wherein the aluminum alloy further contains magnesium in a quantity of not less than 0.45 wt % and not more than 0.90 wt %.

5. The magnet roll according to claim 1,
wherein a size of the grain boundaries is between 5 μm and 30 μm.

6. The magnet roll according to claim 1,
wherein a size of the grain boundaries is between 10% and 500% of the particle diameter of the toner.

7. The magnet roll according to claim 1,
wherein a size of the carrier is larger than a diameter of the grain boundaries.

8. The magnet roll according to claim 1,
wherein the grain diameter of the toner is between 1 μm and 20 μm.

9. The magnet roll according to claim 1,
wherein the etching is performed by electrolytic etching.

10. The magnet roll according to claim 9,
wherein an etching solution of the etching is a hydrochloric acid water solution.

11. The magnet roll according to claim 1,
wherein the surface of the roll excluding the recesses includes one or more polishing patterns in a circumferential direction of the roll or cutting patterns in a spiral shape.
